(19) United States
(12) Patent Application Publication
(10) Pub. No.: US 2013/0100367 A1
(43) Pub. Date: Apr. 25, 2013

(54) OPTICAL FILM, METHOD FOR MANUFACTURING THE SAME, AND POLARIZING PLATE, IMAGE DISPLAY DEVICE, AND STEREO PICTURE DISPLAY SYSTEM INCLUDING THE OPTICAL FILM

(71) Applicant: FUJIFILM Corporation, Tokyo (JP)

(72) Inventors: Keita TAKAHASHI, Minami-ashigara-shi (JP); Shinichi MORISHIMA, Minami-ashigara-shi (JP)

(73) Assignee: FUJIFILM Corporation, Tokyo (JP)

(21) Appl. No.: 13/714,075

(22) Filed: Dec. 13, 2012

Related U.S. Application Data
(63) Continuation of application No. PCT/JP2011/064049, filed on Jun. 20, 2011.

(30) Foreign Application Priority Data
Jun. 22, 2010 (JP) 2010-141346

(51) Int. Cl. G02F 1/13363; G02F 1/13; G02B 5/30

(52) U.S. Cl. CPC G02F 1/13363; G02B 5/3016; G02F 1/1313
USPC 349/15; 349/194; 349/102

(57) ABSTRACT

Provide is an optical film which includes an optically anisotropic layer having a high-definition alignment pattern, can be readily produced, and is utility. The optical film comprising: a transparent support; an alignment film subjected to a unidirectional alignment treatment; and an optically anisotropic layer formed of one kind of composition mainly containing liquid crystal having a polymerizable group, wherein the optically anisotropic layer is a patterned optically anisotropic layer having first retardation regions and second retardation regions alternately disposed in a plane, and the first retardation regions and the second retardation regions have in-plane slow axes orthogonal to each other.

The present application is a continuation of PCT/JP2011/064049 filed on Jun. 20, 2011 and claims priority under 35 U.S.C. §119 of Japanese Patent Application No. 141346/2010, filed on Jun. 22, 2010.

### BACKGROUND OF THE INVENTION

1. Field of the Invention

The present invention relates to an optical film and a method for manufacturing the optical film, in which the optical film includes an optically anisotropic layer provided with a high-definition alignment pattern, can be readily produced, and is useful. The present invention also relates to a polarizing plate, an image display device, and a stereo picture display system each including the optical film, the image display device and the stereo picture display system capable of displaying stereoscopic images.

2. Description of the Related Art

Three-dimensional (3D) image display devices for displaying stereoscopic images need optical components which convert images for right and left eyes into, for example, circularly polarized images having opposite circular polarization directions, respectively. Production of such optical components involves patterning techniques to regularly arrange different regions in which a polarizing film has absorption axes in different directions and a retardation film has slow axes in different directions, respectively.

For example, JP-A-10-90675 discloses a process of manufacturing an optical rotatory device using a photoresist material to form a pattern consisting of rotatory and non-rotatory regions. Unfortunately, the process involves multiple steps and is not therefore suitable for industrial production in some cases.

For instance, JP-A-10-153707 discloses a process of manufacturing a retardation sheet using a photoisomerized material to form first and second regions respectively having a fast axis and a slow axis in different directions. Since the process has a restriction on the materials to be used, it is difficult to develop properties suitable for a variety of applications in some cases.

A patterned elliptically-polarizing plate and an optically anisotropic member which can be produced with a photo alignment layer are disclosed in JP-A-2009-193014 and JP-A-2007-71952, respectively. In a technique involving use of a photo alignment film, the photo alignment film must be irradiated with light in different directions for an alignment treatment, which makes its production complicated. A technique involving use of a rubbed alignment film for production of a patterned optically anisotropic layer is also known; however, such a technique always needs a mask rubbing treatment in different directions, resulting in complicated process.

### SUMMARY OF THE INVENTION

If processes of manufacturing patterned optically anisotropic layers do not need steps of an alignment treatment in different directions, the patterned optically anisotropic layers can be produced through a remarkably simple process, which is advantageous for continuous production. In general, it has been traditionally believed that production of patterned optically anisotropic layers needs alignment films subjected to alignment treatment in different directions, such as a photo alignment film irradiated with light in different directions and a rubbed alignment film subjected to a mask rubbing treatment in different directions, as described above, while it has not been typically believed that alignment films subjected to a unidirectional alignment treatment alone can be used to produce optically anisotropic patterned layers.

It is a first object of the present invention to provide an optical film which includes an optically anisotropic layer having a high-definition alignment pattern, can be readily produced, and is useful. It is a second object of the present invention to provide a simple method for manufacturing the optical film. It is a third object of the present invention to provide an image display device and a stereo picture display system which can be produced at low cost and exhibit high visibility.

The objects of the present invention can be accomplished by the following means:

[1] An optical film comprising:

a transparent support;

an alignment film subjected to a unidirectional alignment treatment; and

an optically anisotropic layer formed of one kind of composition mainly containing liquid crystal having a polymerizable group, wherein the optically anisotropic layer is a patterned optically anisotropic layer having first retardation regions and second retardation regions alternately disposed in a plane, and the first retardation regions and the second retardation regions have in-plane slow axes orthogonal to each other.

[2] The optical film according to [1], wherein the alignment film is an unidirectionally rubbed alignment film.

[3] The optical film according to [1] or [2], wherein the optical film has an in-plane retardation Re(550) of 110 to 165 nm at a wavelength of 550 nm.

[4] The optical film according to any one of [1] to [3], wherein the transparent support has an Re(550) of 0 to 10 nm.

[5] The optical film according to any one of [1] to [4], wherein the optical film has a thickness-direction retardation Rth (550) satisfying the relationship: |Rth(550)|≦20 at a wavelength of 550 nm, where Rth(550) are retardation (nm) along the thickness direction at a wavelength of 550 nm.

[6] The optical film according to any one of [1] to [5], wherein the alignment film is a film containing mainly composed of modified polyvinyl alcohol or unmodified polyvinyl alcohol.

[7] The optical film according to any one of [1] to [6], wherein the liquid crystal having a polymerizable group is discotic liquid crystal.

[8] The optical film according to any one of [1] to [7], wherein the optically anisotropic layer further comprises at least any one of a pyridinium compound and an imidazolium compound.

[9] The optical film according to any one of [1] to [8], wherein the optically anisotropic layer further comprises a pyridinium compound represented by Formula (2a) or an imidazolium compound represented by Formula (2b);

Formula (2a):

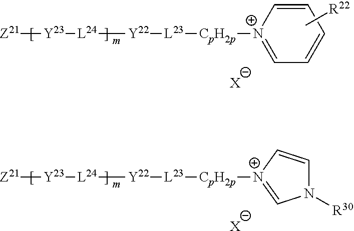

wherein L²³ and L²⁴ each represent a divalent linking group (including a single bond); R²² represents any one of an hydrogen atom, an un-substituted amino group, and a substituted amino group having 1 to 20 carbon atoms; when R²² is a dialkyl-substituted amino group, two alkyl groups may be bonded to each other to form a nitrogen-containing heterocycle; X represents an anion; Y²² and Y²³ each represent a divalent linking group having any one of 5 and 6-membered rings as a partial structure; m is 1 or 2; when m is 2, multiple Y²³'s and L²⁴'s may be the same or different; Z²¹ represents a monovalent group selected from the group consisting of halogen-substituted phenyl, nitro-substituted phenyl, cyano-substituted phenyl, phenyl substituted with an alkyl group having 1 to 10 carbon atoms, phenyl substituted with an alkoxy group having 2 to 10 carbon atoms, an alkyl group having 1 to 12 carbon atoms, an alkynyl group having 2 to 20 carbon atoms, an alkoxy group having 1 to 12 carbon atoms, an alkoxycarbonyl group having 2 to 13 carbon atoms, an aryloxycarbonyl group having 7 to 26 carbon atoms, and an arylcarbonyloxy group having 7 to 26 carbon atoms; p represents an integer of from 1 to 10, and R³⁰ represents a hydrogen atom or an alkyl group having 1 to 12 carbon atoms.

[10] The optical film according to any one of [1] to [9], wherein the optically anisotropic layer further comprises at least one fluoroaliphatic group-containing copolymer.

[11] The optical film according to any one of [1] to [10], wherein the liquid crystal having a polymerizable group is discotic liquid crystal, and the molecules of the discotic liquid crystal are aligned into a vertically alignment state in the optically anisotropic layer.

[12] A polarizing plate comprising:

the optical film according to any one of [1] to [11]; and

a polarizing film, wherein

the direction of the in-plane slow axis of each of the first and second retardation regions of the optically anisotropic layer is 45° from the direction of the absorption axis of the polarizing film.

[13] The polarizing plate according to [12], wherein the optical film and the polarizing film are laminated with an adhesive layer interposed therebetween.

[14] The polarizing plate according to [12] or [13], wherein at least one antireflection film is laminated as the outermost layer.

[15] An image display device comprising:

a first polarizing film and a second polarizing film;

a liquid crystal cell disposed between the first and second polarizing films and including a pair of substrates and a liquid crystal layer disposed between the substrates, at least any one of the substrates having an electrode; and

the optical film according to [1] or [2] disposed at the outer side relative to the first polarizing film, wherein

the in-plane slow axes of each the first and second retardation regions in the optical film each are ±45° from the absorption axis direction of the first polarizing film.

[16] A stereoscopic image display system comprising:

the image display device according to [15]; and

a third polarizing plate disposed at the outer side relative to the optical film, wherein

the stereoscopic image display system enables an stereoscopic image to be visually observed through the third polarizing plate.

[17] A method for manufacturing the optical film according to any one of [1] to [11], the method comprising, in the sequence set forth,

forming an alignment film on a transparent support;

unidirectionally rubbing the alignment film;

applying one kind of composition mainly composed of liquid crystal having a polymerizable group onto the rubbed alignment film;

heating the laminate at a temperature T₁° C. to align liquid crystal molecules such that slow axes thereof are orthogonal to the rubbed direction;

exposing the laminate to ultraviolet rays through a photomask to fix the irradiated region in the orthogonal alignment state;

heating the laminate at a temperature T₂° C. (where T₁<T₂) to align the liquid crystal molecules in the non-irradiated region such that slow axes thereof are parallel to the rubbed direction; and

irradiating the laminate with ultraviolet rays to fix the parallel alignment state.

The present invention can provide an optical film which includes an optically anisotropic layer having a high-definition alignment pattern, can be readily produced, and is useful.

The present invention can also provide a simple method for manufacturing the optical film.

The present invention can also provide an image display device and stereo picture display system which can be produced at low cost and exhibit high visibility.

### BRIEF DESCRIPTION OF THE DRAWINGS

FIG. 1 is a cross-sectional view illustrating an optical film of an embodiment of the present invention.

FIG. 2 is a schematic top view illustrating a patterned optically anisotropic layer of an embodiment of the present invention.

FIG. 3 is a schematic top view illustrating an alignment film of an embodiment of the present invention.

FIG. 4 is a schematic cross-sectional view illustrating a polarizing plate of an embodiment of the present invention.

FIG. 5 illustrates the result of an evaluation for the optical properties of an optical film produced in Examples.

FIG. 6 illustrates the result of the evaluation for the optical properties of the optical film produced in Examples.

FIG. 7 illustrates the result of the evaluation for the optical properties of the optical film produced in Examples.

FIG. 8 illustrates the result of an evaluation for the optical properties of another optical film produced in Examples.

FIG. 9 illustrates the result of the evaluation for the optical properties of the optical film produced in Examples.

FIG. 10 illustrates the result of the evaluation for the optical properties of the optical film produced in Examples.

### BEST MODE FOR CARRYING OUT THE INVENTION

The invention is described in detail hereinunder. In this description, the numerical range expressed by the wording “a number to another number” means the range that falls between the former number indicating the lowermost limit of the range and the latter number indicating the uppermost limit thereof. First described are the terms used in this description.

In this description, “visible light” means from 380 nm to 780 nm. Unless otherwise specifically defined in point of the wavelength in measurement in this description, the wavelength in measurement is 550 nm.

In this description, the angle (for example, “90°”, etc.) and the relational expressions thereto (for example, “perpendicular”, “parallel”, “crossing at 45”, etc.) should be so interpreted as to include the error range generally acceptable in the technical field to which the invention belongs. For example, this means within a range of a strict angle ±less than 10°, and the error from the string angle is preferably at most 5°, more preferably at most 3°.

### 1. Optical Film

The present invention relates to an optical film at least including a transparent substrate, an alignment film subjected to a unidirectional alignment treatment, and an optically anisotropic layer composed of one kind of composition mainly containing liquid crystal having a polymerizable group, wherein the optically anisotropic layer is a patterned optically anisotropic layer having first retardation regions and second retardation regions alternately disposed in a plane, and the first retardation regions and the second retardation regions have in-plane slow axes orthogonal to each other. The optical film of the present invention is disposed at the outer side relative to a viewing-side polarizer in a stereo picture display device, and polarization images which have passed through the first and second retardation regions of the optical film can be visually observed as images for right and left eyes through polarizing glasses or other members. Preferably, the first and second retardation regions have the same shape not so as to cause unevenness between an image for a right eye and an image for a left eye and the first and second retardation regions are uniformly and symmetrically disposed.

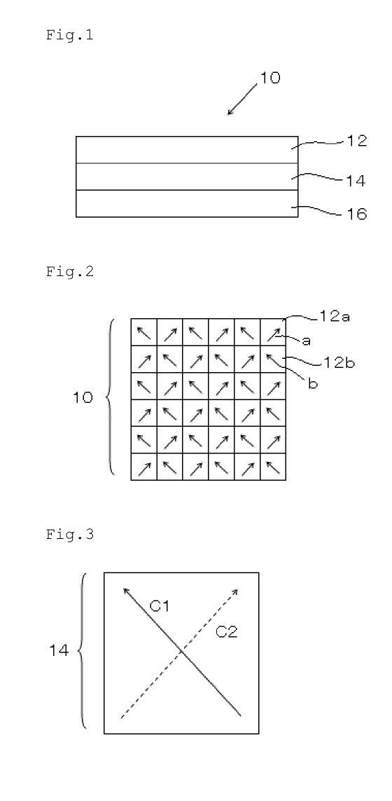

FIGS. 1 and 2 are a schematic cross-sectional view and a top view, respectively, of an optical film according to an embodiment of the present invention. An optical film 10 illustrated in FIGS. 1 and 2 includes a transparent support 16, an alignment film 14, and an optically anisotropic layer 12, and the optically anisotropic layer 12 is a patterned optically anisotropic layer having first and second retardation regions 12a and 12b which are uniformly and symmetrically disposed in an image display device. The first and second retardation regions 12a and 12b have orthogonal in-plane slow axes a and b, respectively. In an embodiment utilizing circularly polarized light, the optical film 10 preferably has a Re of λ/4, in particular, in the range of 110 to 165 nm. The Re is further preferably in the range of 120 to 145 nm, particularly preferably 130 to 145 nm. In the case where the transparent support 16 is a retardation film, the Re of the entire optical film, including the Re of the transparent support 16, is preferably within the above-mentioned ranges. A smaller Rth is preferred in terms of a reduction in crosstalk; in particular, the absolute value of the Rth of the entire optical film is preferably not more than 20 nm.

The alignment film 14 of the optical film 10 is a rubbed alignment film which has been rubbed in C1 or C2 direction corresponding to the in-plane slow axis a of the first retardation region 12a and the in-plane slow axis b of the second retardation region 12b, respectively. Since rubbed alignment films can generally maintain their alignment-controlling force even though the rubbed alignment films have a certain level of thickness, the uneven surface of the transparent support 16 can be planarized by forming an alignment film having a thickness which can compensate for the unevenness. In contrast, optical alignment films must have a reduced thickness for sufficient alignment control and therefore don't have a thickness enough to planarize the uneven surface of the transparent support in some cases. The present embodiment utilizing the rubbed alignment film is preferred in terms of planarization of the uneven surface of a transparent support for suitable production of a patterned optically anisotropic layer.

A method for manufacturing the optical film of the present invention and components thereof will now be described in detail.

### (1) Method for Manufacturing Optical Film

For example, an exemplary method for manufacturing the optical film of the present invention includes, in the sequence set forth, of:

1) forming an alignment film on a transparent support;

2) rubbing unidirectionally the alignment film;

3) coating one kind of composition mainly composed of liquid crystal having a polymerizable group onto the rubbed alignment film;

4) heating the laminate at a temperature T₁° C. to align liquid crystal molecules such that their slow axes are orthogonal to the rubbed direction;

5) exposing the laminate to ultraviolet rays through a photomask to fix the irradiated region in the orthogonal alignment state;

6) heating the laminate at a temperature T₂° C. (where T₁<T₂) to align the liquid crystal molecules in the non-irradiated region such that their slow axes are parallel to the rubbed direction; and

7) irradiating the laminate with ultraviolet rays to fix the parallel alignment state.

In the method, the unidirectionally rubbed alignment film is used to form a patterned optically anisotropic layer. The rubbed alignment film has an alignment-controlling function imparted by a rubbing treatment, and its alignment axis is determined depending on the direction of the rubbing treatment and heating conditions. In general, if liquid crystal molecules are aligned on a unidirectionally rubbed alignment film, the liquid crystal molecules are aligned such that their slow axes are orthogonal or parallel to the rubbed direction. An alignment state of the liquid crystal molecules is determined by one or more factors selected from a material of the alignment film, liquid crystal, and an alignment-controlling agent. In the above-mentioned process, for example, affinity between any two or three of the materials of the alignment film, liquid crystal, and alignment-controlling agent are varied at a variable temperature to provide an alignment state of the liquid crystal molecules in which their slow axes are orthogonal and parallel to the rubbed direction, respectively. Liquid crystal molecules are aligned in the orthogonal alignment state at a temperature T₁° C., then are irradiated with ultraviolet rays through a photomask to fix the alignment state into a predetermined pattern, and then the liquid crystal molecules in the non-irradiated region are aligned into the parallel alignment state at a temperature T₂° C. (where T₁<T₂). Further irradiation with ultraviolet rays is carried out to fix this alignment state, which enables formation of the patterned optically anisotropic layer having the first and second retardation regions with orthogonal in-plane slow axes. The first and second retardation regions can be formed in a predetermined shape and arrangement by selecting the type of the photomask used in the step 5). In an embodiment of the optical film that is used in a stereo picture display device, the first and second retardation regions preferably have strip shapes having short sides with a substantially identical length and are alternately and continuously arranged in a pattern.

In the method described above, an increase in temperature from a temperature T₁ to T₂° C. can shift the alignment state from the orthogonal alignment state to the parallel alignment state. At a temperature T₁° C., an interaction between any two or three of the material of the alignment film, liquid crystal, and an alignment-controlling agent can control the alignment state, and liquid crystal molecules are aligned such that their slow axes are orthogonal to the rubbed direction. At an elevated temperature T₂° C., such an interaction weakens, and the rubbed direction of the rubbed alignment film controls the alignment state, so that the liquid crystal molecules are parallel aligned such that their slow axes are parallel to the rubbed direction. Preferred ranges of the temperatures T₁ and T₂° C. for achieving such alignment states vary depending on the types of materials to be used and cannot be therefore indiscriminately defined. In an example, the temperature T₁° C. preferably ranges from 60 to 90° C. The temperature T₂° C. may be higher than the isotropic phase transition temperature of the liquid crystal compound provided that the alignment control of the alignment film can be secured and the temperature does not deteriorate the polymer film used as a support. In general, the temperature T₂° C. is higher than 90° C. and not more than 180° C.

A heating step may be introduced between the steps 3) and 4) to volatilize the solvent contained in the composition. The heating temperature may be higher or lower than the T₁° C. or may be the same as the T₁° C.

In steps 5) and 7), the laminate is irradiated with ultraviolet rays to facilitate a polymerization reaction of the liquid crystal compound. The irradiation energy preferably ranges from 10 mJ/cm² to 10 J/cm², more preferably 25 to 800 mJ/cm². The illuminance is preferably in the range of 10 to 1000 mW/cm², more preferably 20 to 500 mW/cm², and further preferably 40 to 350 mW/cm². The peak wavelength of the light preferably ranges from 250 to 450 nm, more preferably 300 to 410 nm. The irradiation with light may be carried out under an inert gas atmosphere, such as nitrogen, or thermal conditions to facilitate a photopolymerization reaction. Preferred examples of the light source to be used include low-pressure mercury lamps (e.g., bactericidal lamps, fluorescent chemical lamps, and black lights), high-pressure discharge lamps (e.g., high-pressure mercury lamps and metal halide lamps), and high-voltage short-arc discharge lamps (e.g., ultra high-pressure mercury lamps, xenon lamps, and mercury-xenon lamps).

In step 5), liquid crystal molecules are aligned in an orthogonal alignment state, the laminate is then irradiated with ultraviolet rays through a photomask to facilitate polymerization, and then the alignment state is fixed to form the first retardation regions. In the irradiation with ultraviolet rays through the photomask, the intensity of the exposed light is preferably in the range of approximately 50 to 1000 mJ/cm², more preferably approximately 50 to 200 mJ/cm². In order to enhance the resolution of the pattern, the laminate is preferably exposed to light at room temperature.

Then, the temperature is increased to the T₂° C. to align the liquid crystal molecules in a parallel alignment state, the entire laminate is subsequently irradiated with ultraviolet rays again to facilitate the polymerization reaction, and then the alignment state is fixed to form the second retardation regions. In step (g), the intensity of exposed light preferably ranges from approximately 200 to 2000 mJ/cm², more preferably approximately 500 to 1000 mJ/cm².

The exposure temperature is preferably controlled, so that the first and second retardation regions can have the same in-plane retardation (Re) and the same retardation in the thickness direction (Rth). For instance, the step 5) may be carried out at a temperature T₁° C. or may be carried out after the temperature is decreased to room temperature. Furthermore, the step 6) may be carried out at a temperature T₂° C. or may be carried out after the temperature is decreased to a level lower than the temperature T₂° C. In this case, the exposure to light is preferably carried out at the same temperature as those in the steps 5) and 6), so that the first and second retardation regions can exhibit the same Re and Rth.

### Rubbed Alignment Film

The rubbed alignment film is formed through the steps 1) and 2). The rubbed alignment film usable in the present invention includes films which have been subjected to a rubbing treatment to develop a function to control alignment of liquid crystal molecules. The rubbed alignment film has an alignment axis for controlling alignment of liquid crystal molecules, and the liquid crystal molecules are aligned in accordance with the alignment axis. In the present invention, the material of the alignment film, liquid crystal, and an alignment-controlling agent are selected so that liquid crystal molecules aligned to be a state in which the slow axes of the liquid crystal are orthogonal to the rubbed direction at the temperature T₁° C. and then the alignment of liquid crystal molecules shifts to be a state in which their slow axes are parallel to the rubbed direction at the temperature T₂° C. (T₁<T₂).

The rubbed alignment layer generally comprises a polymer as the main ingredient thereof. Regarding the polymer material for the alignment layer, a large number of substances are described in literature, and a large number of commercial products are available. The polymer material for use in the invention is preferably polyvinyl alcohol or polyimide, and their derivatives. Especially preferred are modified or unmodified polyvinyl alcohols. Polyvinyl alcohols having a different degree of saponification are known. In the invention, preferred is use of those having a degree of saponification of from 85 to 99 or so. Commercial products are usable here, and for example, “PVA103”, “PVA203” (by Kuraray) and others are PVAs having the above-mentioned degree of saponification. Regarding the rubbed alignment layer, referred to are the modified polyvinyl alcohols described in WO01/88574A1, from page 43, line 24 to page 49, line 8, and Japanese Patent 3907735, paragraphs [0071] to [0095]. Preferably, the thickness of the rubbed alignment layer is from 0.01 to 10 micro meters, more preferably from 0.01 to 1 micro meters.

The rubbing treatment may be attained generally by rubbing the surface of a film formed mainly of a polymer, a few times with paper or cloth in a predetermined direction. A general method of rubbing treatment is described, for example, in “Liquid Crystal. Handbook” (published by Maruzen, Oct. 30, 2000).

Regarding the method of changing the rubbing density, employable is the method described in “Liquid Crystal Handbook” (published by Maruzen). The rubbing density (L) is quantified by the following (A):

L=N1(1+2πrn/60v) (A)

wherein N means the rubbing frequency, 1 means the contact length of the rubbing roller, r means the radius of the roller, n is the rotation number of the roller (rpm), and v means the stage moving speed (per second).

For increasing the rubbing density, the rubbing frequency is increased, the contact length of the rubbing roller is prolonged, the radius of the roller is increased, the rotation number of the roller is increased, the stage moving speed is lowered; but on the contrary, for decreasing the rubbing density, the above are reversed.

The relationship between the rubbing density and the pretilt angle of the alignment layer is that, when the rubbing density is higher, then the pretilt angle is smaller, but when the rubbing density is lower, then the pretilt angle is larger.

For sticking an alignment layer to a long polarizing film of which the absorption axis is in the lengthwise direction thereof, preferably, an alignment layer is formed on a long support of polymer film, and then continuously rubbed in the direction at 45° relative to the lengthwise direction, thereby forming the intended rubbed alignment layer.

### Optically Anisotropic Layer

In the step 3), a composition of mainly composed of liquid crystal having a polymerizable group prepared as a coating solution is applied onto the rubbed surface of the alignment film. Any coating process can be used, and examples of the coating process include traditional techniques such as curtain coating, dipping, spin coating, printing, spraying, slot coating, roll coating, slide coating, blade coating, gravure coating, and wire bar coating.

In the steps 4) and 6), the slow axes of liquid crystal molecules are aligned in the direction orthogonal and parallel to the rubbed direction, respectively. These steps determine the directions of the first and second in-plane slow axes, so that the first and second retardation regions having orthogonal in-plane slow axes are formed. The alignment states of the liquid crystal molecules in these steps determine the optical characteristics (Re and Rth) of the optically anisotropic layer. The optically anisotropic layer is preferably a λ/4 plate, namely, an optically anisotropic layer having a function to convert linearly polarized light into a circularly polarized light. The optically anisotropic layer which functions as a λ/4 plate can be produced through a variety of processes. For example, a production process involves fixing the slow axis of a rod-like liquid crystal compound having a polymerizable group in a horizontal alignment state relative to a plane of a layer or involves fixing the discotic plane of the molecules of discotic liquid crystal in an orthogonal alignment state relative to a plane of a layer. Preferred is the process which involves fixing the molecules of discotic liquid crystal in a vertical alignment state.

For instance, the optically anisotropic layer is composed of a liquid crystal composition containing at least one liquid crystal compounds having a polymerizable group and at least one alignment-controlling agents. The liquid crystal composition may further contain a polymerization initiator and a sensitizer.

Each component will now be described in detail.

### Liquid Crystal Compound Having a Polymerizable Group

Examples of the liquid crystal, which can be used as a main ingredient for the optically anisotropic layer of the invention, include rod-like liquid crystals and discotic liquid crystals. Discotic liquid crystals are preferable, and discotic liquid crystals having a polymerizable group are more preferable as described above.

Examples of the polymerizable rod-like liquid crystal compound include those described in Makromol. Chem., vol. 190, p. 2255 (1989), Advanced Materials, vol. 5, p. 107 (1993), U.S. Pat. No. 4,683,327, U.S. Pat. No. 5,622,648, U.S. Pat. No. 5,770,107, WO95/22586, WO95/24455, WO97/00600, WO98/23580, WO98/52905, JPA No. 1-272551, JPA No. 6-16616, JPA No. 7-110469, JPA No. 11-80081 and JPA No. 2001-328973. Plural types of polymerizable rod-like liquid crystal compounds may be used in combination, and any compound selected from those described in the documents may be used.

The low-molecular weight rod-like liquid crystal compound is preferably selected from formula (X).

Q¹-L¹-Cy¹-L²-(Cy²-L³)ₙ-Cy³-L⁴-Q² Formula (X)

In the formula, Q¹ and Q² each independently represent a polymerizable group; L¹ and L⁴ each independently represent a divalent linking group; L² and L³ each independently represent a single bond or a divalent linking group; Cy¹, Cy² and Cy³ each independently represent a divalent cyclic group; and n is 0, 1 or 2.

In the formula, Q¹ and Q² each independently represent a polymerizable group. The polymerization of the polymerizable group is an addition polymerization (including ring-opening polymerization) or a condensation polymerization. In other words, the polymerizable group is preferably a functional group capable of addition polymerization or condensation polymerization.

The discotic liquid crystal which can be used in the present invention as a main ingredient of the optically anisotropic layer is preferably selected from the discotic liquid crystal compounds having a polymerizable group as describe above.

The discotic liquid crystal is preferably selected from the compounds represented by formula (I).

D(-L-H-Q)ₙ (I)

In the formula, D represents a disc-like core; L represents a divalent linking group; H represents a divalent aromatic ring or a heterocyclic ring; Q is a group containing a polymerizable group; and n is an integer of from 3 to 12.

The disc-like core (D) is preferably a benzene ring, naphthalene ring, triphenylene ring, anthraquinone ring, truxene ring, pyridine ring, pyrimidine ring, or triazine ring, or especially preferably a benzene ring, triphenylene ring, pyridine ring, pyrimidine ring or triazine ring.

L is preferably selected from the divalent liking group consisting of *—O—CO—, *—CO—O—, *—CH═CH—, *—C≡C— and any combinations thereof, or is especially preferably a divalent linking group containing at least one of *—CH═CH— and *—C≡C—. The symbol of “*” is a site bonding to D of the formula (I).

The aromatic ring represented by H is preferably a benzene ring or a naphthalene ring, or is more preferably a benzene ring. The heterocyclic ring represented by H is preferably a pyridine ring or pyrimidine ring, or is more preferably a pyridine ring. Preferably, H is an aromatic ring.

The polymerization of the polymerizable group in the group Q is an addition polymerization (including ring-opening polymerization) or a condensation polymerization. In other words, the polymerizable group is preferably a functional group capable of addition polymerization or condensation polymerization. Among them, a (meth)acrylate or epoxy group is preferable.

The discotic liquid crystal represented by the formula (I) is preferably selected from the formula (II) or (III).

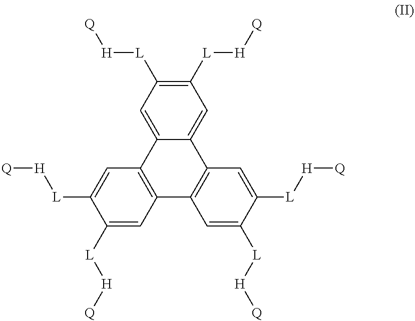

In the formula, the definitions of L, H and Q are same as those of L, H and Q in the formula (I) respectively; and the preferable examples thereof are same as those of L, H and Q in the formula (I) respectively.

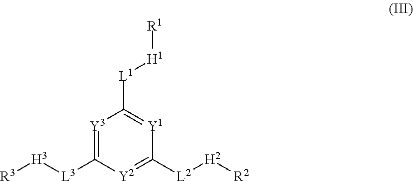

In the formula, the definitions of Y¹, Y² and Y³ are same as those of Y¹¹, Y¹² and Y¹³ in the formula (IV) described later respectively, and the preferable examples thereof are same as those of Y¹¹, Y¹² and Y¹³ in the formula (IV) respectively. Or the definitions of L¹, L², L³, H¹, H², H³, R¹, R² and R³ are same as those of L¹, L², L³, H¹, H², H³, R¹, R² and R³ in the formula (IV) described later respectively, and the preferable examples thereof are same as those of L¹, L², L³, H¹, H², H³, R¹, R² and R³ in the formula (IV) described later respectively.

As described later, the discotic liquid crystal having plural aromatic rings such as the compounds represented by formula (I), (II) (III) or (IV) may interact with the onium salt such as pyridium or imidazolium compound to be used as an alignment controlling agent by the n-n molecular interaction, thereby to achieve the vertical alignment. Especially, for example, the compound represented by the formula (II) in which L represents a divalent linking group containing at least one selected from *—CH_CH— and *—C≡C—, or the compound represented by formula (III) in which plural aromatic rings or heterocyclic rings are connected via a single bond to each other may keep the linearity of the molecule thereof since the free rotation of the bonding may be restricted strongly by the linking group. Therefore, the liquid crystallinity of the compound may be improved and the compound may achieve the more stable vertical alignment by the stronger intermolecular n-n interaction.

The discotic liquid crystal is preferably selected from the compounds represented by formula (IV)

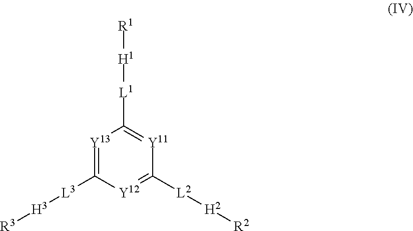

In the formula, Y¹¹, Y¹² and Y¹³ each independently represent a methine group or a nitrogen atom.

When each of Y¹¹, Y¹² and Y¹³ each is a methine group, the hydrogen atom of the methine group may be substituted with a substituent. Examples of the substituent of the methine group include an alkyl group, an alkoxy group, an aryloxy group, an acyl group, an alkoxycarbonyl group, an acyloxy group, an acylamino group, an alkoxycarbonylamino group, an alkylthio group, an arylthio group, a halogen atom, and a cyano group. Among those, preferred are an alkyl group, an alkoxy group, an alkoxycarbonyl group, an acyloxy group, a halogen atom and a cyano group; more preferred are an alkyl group having from 1 to 12 carbon atoms, an alkoxy group having from 1 to 12 carbon atoms, an alkoxycarbonyl group having from 2 to 12 carbon atoms, an acyloxy group having from 2 to 12 carbon atoms, a halogen atom and a cyano group.

Preferably, Y¹¹, Y¹² and Y¹³ are all methine groups, more preferably non-substituted methine groups, in terms of easiness in preparation of the compound.

In the formula, L¹, L² and L³ each independently represent a single bond or a bivalent linking group.

The bivalent linking group is preferably selected from —O—, —S—, —C(═O)—, —NR⁷—, —CH═CH—, —C≡C—, a bivalent cyclic group, and their combinations. R⁷ represents an alkyl group having from 1 to 7 carbon atoms, or a hydrogen atom, preferably an alkyl group having from 1 to 4 carbon atoms, or a hydrogen atom, more preferably a methyl, an ethyl or a hydrogen atom, even more preferably a hydrogen atom.

The bivalent cyclic group for L¹, L² and L³ is preferably a 5-membered, 6-membered or 7-membered group, more preferably a 5-membered or 6-membered group, or even more preferably a 6-membered group. The ring in the cyclic group may be a condensed ring. However, a monocyclic ring is preferred to a condensed ring for it. The ring in the cyclic group may be any of an aromatic ring, an aliphatic ring, or a heterocyclic ring. Examples of the aromatic ring are a benzene ring and a naphthalene ring. An example of the aliphatic ring is a cyclohexane ring. Examples of the heterocyclic ring are a pyridine ring and a pyrimidine ring. Preferably, the cyclic group contains an aromatic ring or a heterocyclic ring. According to the invention, the divalent cyclic group is preferably a divalent linking group consisting of a cyclic structure (but the cyclic structure may have any substituent(s)), and the same will be applied to the later.

Of the bivalent cyclic group represented by L¹, L² or L³, the benzene ring-having cyclic group is preferably a 1,4-phenylene group. The naphthalene ring-having cyclic group is preferably a naphthalene-1,5-diyl group or a naphthalene-2,6-diyl group. The pyridine ring-having cyclic group is preferably a pyridine-2,5-diyl group. The pyrimidine ring-having cyclic group is preferably a pyrimidin-2,5-diyl group.

The bivalent cyclic group for L¹, L² and L³ may have a substituent. Examples of the substituent are a halogen atom, a cyano group, a nitro group, an alkyl group having from 1 to 16 carbon atoms, an alkenyl group having from 2 to 16 carbon atoms, an alkynyl group having from 2 to 16 carbon atoms, a halogen atom-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms.

In the formula, L¹, L² and L³ are preferably a single bond, *—O—CO—, *—CO—O—, *—CH═CH—, *—C≡C—, *-“bivalent cyclic group”-, *—O—CO-“bivalent cyclic group”-, *—CO—O-“bivalent cyclic group”-, *—CH═CH-“bivalent cyclic group”-, *—C≡C-“bivalent cyclic group”-, *-“bivalent cyclic group”-O—CO—, *-“bivalent cyclic group”-CO—O—, *-“bivalent cyclic group”-CH═CH—, or *-“bivalent cyclic group”-C≡C—. More preferably, they are a single bond, *—CH═CH—, *—CH═CH-“bivalent cyclic group”- or *—C≡C-“bivalent cyclic group”-, even more preferably a single bond. In the examples, “*” indicates the position at which the group bonds to the 6-membered ring of formula (IV) that contains Y¹² and Y¹³.

In the formula (I), H¹, H² and H³ each independently represent the following formula (IV-A) or (IV-B):

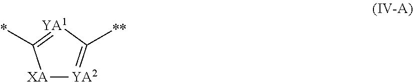

In formula (IV-A), YA¹ and YA² each independently represent a methine group or a nitrogen atom;

XA represents an oxygen atom, a sulfur atom, a methylene group or an imino group;

* indicates the position at which the formula bonds to any of L¹ to L³; and

** indicates the position at which the formula bonds to any of R¹ to R³.

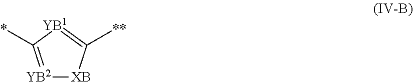

In formula (IV-B), YB¹ and YB² each independently represent a methine group or a nitrogen atom;

XB represents an oxygen atom, a sulfur atom, a methylene group or an imino group;

* indicates the position at which the formula bonds to any of L¹ to L³; and

** indicates the position at which the formula bonds to any of R¹ to R³.

In the formula, R¹, R² and R³ each independently represent the following formula (IV-R):

*-(-L²¹-Q²)ₙ₁-L²²-L²³-Q¹ (IV-R)

In formula (IV-R), * indicates the position at which the formula bonds to H¹, H² or H³ in formula (IV).

L²¹ represents a single bond or a bivalent linking group. When L²¹ is a bivalent linking group, it is preferably selected from a group consisting of —O—, —S—, —C(═O)—, —NR⁷—, —CH_CH—, —C≡C—, and their combination. R⁷ represents an alkyl group having from 1 to 7 carbon atoms, or a hydrogen atom, preferably an alkyl group having from 1 to 4 carbon atoms, or a hydrogen atom, more preferably a methyl group, an ethyl group or a hydrogen atom, even more preferably a hydrogen atom.

In the formula, L²¹ is preferably a single bond, **—O—CO—, **—CO—O—, **—CH═CH— or **—C≡C— (in which ** indicates the left side of L²¹ in formula (DI-R)). More preferably it is a single bond.

In the formula, Q² represents a bivalent cyclic linking group having at least one cyclic structure. The cyclic structure is preferably a 5-membered ring, a 6-membered ring, or a 7-membered ring, more preferably a 5-membered ring or a 6-membered ring, even more preferably a 6-membered ring. The cyclic structure may be a condensed ring. However, a monocyclic ring is preferred to a condensed ring for it. The ring in the cyclic ring may be any of an aromatic ring, an aliphatic ring, or a hetero ring. Examples of the aromatic ring are a benzene ring, a naphthalene ring, an anthracene ring, and a phenanthrene ring. An example of the aliphatic ring is a cyclohexane ring. Examples of the heterocyclic ring are a pyridine ring and a pyrimidine ring.

The benzene ring-having group for Q² is preferably a 1,4-phenylene group or a 1,3-phenylene group. The naphthalene ring-having group is preferably a naphthalene-1,4-diyl group, a naphthalene-1,5-diyl group, a naphthalene-1,6-diyl group, a naphthalene-2,5-diyl group, a naphthalene-2,6-diyl group, or a naphthalene-2,7-diyl group. The cyclohexane ring-having group is preferably a 1,4-cyclohexylene group. The pyridine ring-having group is preferably a pyridine-2,5-diyl group. The pyrimidine ring-having group is preferably a pyrimidin-2,5-diyl group. More preferably, Q² is a 1,4-phenylene group, a nephthalen-2,6-diyl group, or a 1,4-cyclohexylene group.

In the formula, Q² may have a substituent. Examples of the substituent are a halogen atom (e.g., fluorine atom, chlorine atom, bromine atom, iodine atom), a cyano group, a nitro group, an alkyl group having from 1 to 16 carbon atoms, an alkenyl group having from 1 to 16 carbon atoms, an alkynyl group having from 2 to 16 carbon atoms, a halogen atom-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. The substituent is preferably a halogen atom, a cyano group, an alkyl group having from 1 to 6 carbon atoms, a halogen atom-substituted alkyl group having from 1 to 6 carbon atoms, more preferably a halogen atom, an alkyl group having from 1 to 4 carbon atoms, a halogen atom-substituted alkyl group having from 1 to 4 carbon atoms, even more preferably a halogen atom, an alkyl group having from 1 to 3 carbon atoms, or a trifluoromethyl group.

In the formula, n1 indicates an integer of from 0 to 4. n1 is preferably an integer of from 1 to 3, or more preferably 1 or 2.

In the formula, L²² represents **—O—, **—O—CO—, **—CO—O—, **—O—CO—O—, **—S—, **—NH—, **—SO₂—, **—CH₂—, **—CH═CH— or and “*” indicates the site bonding to the Q² side. Preferably, L²² represents **—O—, **—O—CO—, **—CO—O—, **—O—CO—O—, **—CH₂—, **—CH═CH— or **—C≡C—, or more preferably, L²² represents **—O—, **—O—CO—, **—CO—O—, **—O—CO—O—, or **—CH₂—. When the above group has a hydrogen atom, then the hydrogen atom may be substituted with a substituent. Examples of the substituent are a halogen atom, a cyano group, a nitro group, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. Especially preferred are a halogen atom, and an alkyl group having from 1 to 6 carbon atoms.

In the formula, L²³ represents a bivalent linking group selected from —O—, —S—, —C(═O)—, —SO₂—, —NH—, —CH₂—, —CH═CH— and —C≡C—, and a group formed by linking two or more of these. The hydrogen atom in —NH—, —CH₂— and —CH═CH— may be substituted with any other substituent. Examples of the substituent are a halogen atom, a cyano group, a nitro group, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. Especially preferred are a halogen atom, and an alkyl group having from 1 to 6 carbon atoms. The group substituted with the substituent improves the solubility of the compound of the formula (IV) in solvent, and therefore the composition can be readily prepared as a coating liquid.

In the formula, L²³ is preferably a linking group selected from a group consisting of —O—, —C(═O)—, —CH₂—, —CH═CH— and —C≡C—, and a group formed by linking two or more of these. L²³ preferably has from 1 to 20 carbon atoms, more preferably from 2 to 14 carbon atoms. Preferably, L²³ has from 1 to 16 (—CH₂—)'s, more preferably from 2 to 12 (—CH₂—)'s.

In the formula, Q¹ represents a polymerizable group or a hydrogen atom. In case where the liquid crystal compound is used in producing optical films of which the retardation is required not to change by heat, such as optical compensatory films, Q¹ is preferably a polymerizable group. The polymerization for the group is preferably addition polymerization (including ring-cleavage polymerization) or polycondensation. In other words, the polymerizable group preferably has a functional group that enables addition polymerization or polycondensation. Examples of the polymerizable group are shown below.

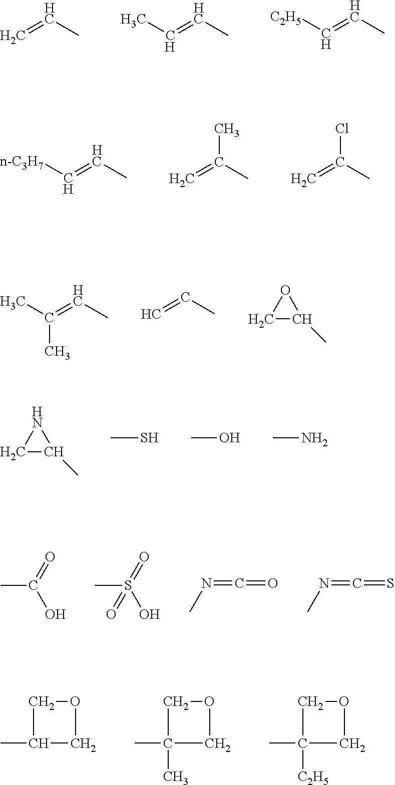

More preferably, the polymerizable group is addition-polymerizing functional group. The polymerizable group of the type is preferably a polymerizable ethylenic unsaturated group or a ring-cleavage polymerizable group.

Examples of the polymerizing ethylenic unsaturated group are the following (M-1) to (M-6):

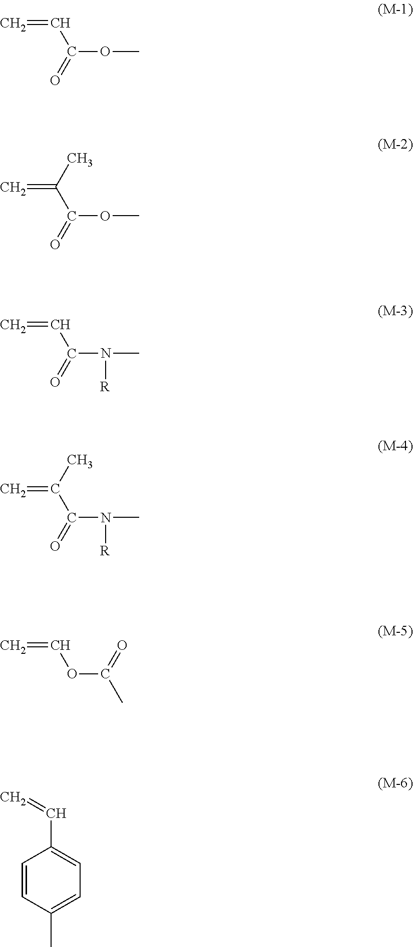

In formulae (M-3) and (M-4), R represents a hydrogen atom or an alkyl group. R is preferably a hydrogen atom or a methyl group.

Of formulae (M-1) to (M-6), preferred are formulae (M-1) and (M-2), and more preferred is formula (M-1).

The ring-cleavage polymerizable group is preferably a cyclic ether group, or more preferably an epoxy group or an oxetanyl group.

Among the compounds represented by formula (IV), the compounds represented by formula (IV′) are more preferable.

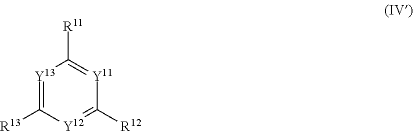

In the formula (DIV), Y¹¹, Y¹² and Y¹³ each independently represent a methine group or a nitrogen atom. Preferably, Y¹¹, Y¹² and Y¹³ are all methine groups, more preferably non-substituted methine groups.

In the formula, R¹¹, R¹² and R¹³ each independently represent the following formula represent the following formula (IV′-A), (IV′-B) or (IV′-C). When the small wavelength dispersion of birefringence is needed, preferably, R¹¹, R¹² and R¹³ each represent the following formula (IV′-A) or (IV′-C), more preferably the following formula (IV′-A). Preferably, R¹¹, R¹² and R¹³ are same (R¹¹═R¹²═R¹³).

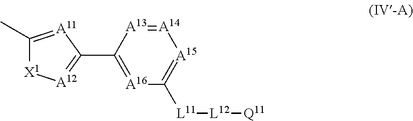

In formula (VI′-A), A¹¹, A¹², A¹³, A¹⁴, A¹⁵ and A¹⁶ each independently represent a methine group or a nitrogen atom.

Preferably, at least one of A¹¹ and A¹² is a nitrogen atom; more preferably the two are both nitrogen atoms.

Preferably, at least three of A¹³, A¹⁴, A¹⁵ and A¹⁶ are methine groups; more preferably, all of them arc methine groups. Non-substituted methine is more preferable.

Examples of the substituent that the methine group represented by A¹¹, A¹², A¹³, A¹⁴, A¹⁵ or A¹⁶ may have are a halogen atom (fluorine atom, chlorine atom, bromine atom, iodine atom), cyano, nitro, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. Of those, preferred are a halogen atom, a cyano group, an alkyl group having from 1 to 6 carbon atoms, a halogen-substituted alkyl group having from 1 to 6 carbon atoms; more preferred are a halogen atom, an alkyl group having from 1 to 4 carbon atoms, a halogen-substituted alkyl group having from 1 to 4 carbon atoms; even more preferred are a halogen atom, an alkyl group having from 1 to 3 carbon atoms, a trifluoromethyl group.

In the formula, X′ represents an oxygen atom, a sulfur atom, a methylene group or an imino group, but is preferably an oxygen atom.

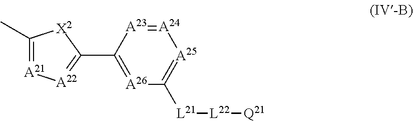

In formula (IV′-B), A²¹, A²², A²³, A²⁴, A²⁵ and A²⁶ each independently represent a methine group or a nitrogen atom.

Preferably, at least either of A²¹ or A²² is a nitrogen atom; more preferably the two are both nitrogen atoms.

Preferably, at least three of A²³, A²⁴, A²⁵ and A²⁶ are methine groups; more preferably, all of them are methine groups.

Examples of the substituent that the methine group represented by A²³, A²⁴, A²⁵ or A²⁶ may have are a halogen atom (fluorine atom, chlorine atom, bromine atom, iodine atom), cyano, nitro, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. Of those, preferred are a halogen atom, a cyano group, an alkyl group having from 1 to 6 carbon atoms, a halogen-substituted alkyl group having from 1 to 6 carbon atoms; more preferred are a halogen atom, an alkyl group having from 1 to 4 carbon atoms, a halogen-substituted alkyl group having from 1 to 4 carbon atoms; even more preferred are a halogen atom, an alkyl group having from 1 to 3 carbon atoms, a trifluoromethyl group.

In the formula, X² represents an oxygen atom, a sulfur atom, a methylene group or an imino group, but is preferably an oxygen atom.

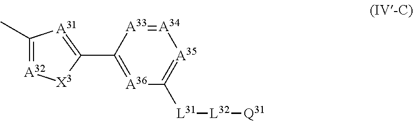

In formula (IV′-C), A³¹, A³², A³³, A³⁴, A³⁵ and A³⁶ each independently represent a methine group or a nitrogen atom.

Preferably, at least either of A³¹ or A³² is a nitrogen atom; more preferably the two are both nitrogen atoms.

Preferably, at least three of A³³, A³⁴, A³⁵ and A³⁶ are methine groups; more preferably, all of them are methine groups.

When A³³, A³⁴, A³⁵ and A³⁶ are methine groups, the hydrogen atom of the methine group may be substituted with a substituent. Examples of the substituent that the methine group may have are a halogen atom (fluorine atom, chlorine atom, bromine atom, iodine atom), cyano, nitro, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. Of those, preferred are a halogen atom, a cyano group, an alkyl group having from 1 to 6 carbon atoms, a halogen-substituted alkyl group having from 1 to 6 carbon atoms; more preferred are a halogen atom, an alkyl group having from 1 to 4 carbon atoms, a halogen-substituted alkyl group having from 1 to 4 carbon atoms; even more preferred are a halogen atom, an alkyl group having from 1 to 3 carbon atoms, a trifluoromethyl group.

In the formula, X³ represents an oxygen atom, a sulfur atom, a methylene group or an imino group, but is preferably an oxygen atom.

L¹¹ in formula (IV′-A), L²¹ in formula (IV′-B) and L³¹ in formula (IV′-C) each independently represent —O—, —O—CO—, —CO—O—, —O—CO—O—, —S—, —NH—, —SO₂—, —CH₂—, —CH═CH— or —C≡C—; preferably —O—, —O—CO—, —CO—O—, —O—CO—O—, —CH₂—, —CH═CH— or —C≡C—; more preferably —O—, —O—CO—, —CO—O—, —O—CO—O— or —C≡C—. L¹¹ in formula (VI′-A) is especially preferable O—, —CO—O— or —C≡C— in terms of the small wavelength dispersion of birefringence; among these, —CO—O— is more preferable because the discotic nematic phase may be formed at a higher temperature. When above group has a hydrogen atom, then the hydrogen atom may be substituted with a substituent. Preferred examples of the substituent are a halogen atom, cyano, nitro, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. Especially preferred are a halogen atom, and an alkyl group having from 1 to 6 carbon atoms.

L¹² in formula (IV′-A), L²² in formula (IV′-B) and L³² in formula (IV′-C) each independently represent a bivalent linking group selected from —O—, —S—, —C(═O)—, —SO₂—, —NH—, —CH₂—, —CH═CH— and —C≡C—, and a group formed by linking two or more of these. The hydrogen atom in —NH—, —CH₂— and —CH═CH— may be substituted with a substituent. Preferred examples of the substituent are a halogen atom, cyano, nitro, hydroxy, carboxyl, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. More preferred are a halogen atom, hydroxy and an alkyl group having from 1 to 6 carbon atoms; and especially preferred are a halogen atom, methyl and ethyl.

Preferably, L¹², L²² and L³² each independently represent a bivalent linking group selected from —O—, —C(═O)—, —CH₂—, —CH═CH— and —C≡C—, a group formed by linking two or more of these.

Preferably, L¹², L²² and L³² each independently have from 1 to 20 carbon atoms, more preferably from 2 to 14 carbon atoms. Preferably, L¹², L²² and L³² each independently have from 1 to 16 (—CH₂—)'s, more preferably from 2 to 12 (—CH₂—)'s.

The number of carbon atoms constituting the L¹², L²² or L³² may influence both of the liquid crystal phase transition temperature and the solubility of the compound. Generally, the compound having the larger number of the carbon atoms has a lower phase transition temperature at which the phase transition from the discotic nematic phase (Nd phase) transits to the isotropic liquid occurs. Furthermore, generally, the solubility for solvent of the compound, having the larger number of the carbon atoms, is more improved.

Q¹¹ in formula (IV′-A), Q²¹ in formula (IV′-B) and Q³¹ in formula (IV′-C) each independently represent a polymerizable group or a hydrogen atom. Preferably Q¹¹, Q²¹ and Q³¹ each represent a polymerizable group. The polymerization for the group is preferably addition polymerization (including ring-cleavage polymerization) or polycondensation. In other words, the polymerizing group preferably has a functional group that enables addition polymerization or polycondensation. Examples of the polymerizable group are same as those exemplified above.

Examples of the compound represented by formula (IV) include the compounds exemplified as “Compound 13”-“Compound 43”, described in JP-A-2006-76992, column 0052; and the compounds exemplified as “Compound 13”-“Compound 36”, described in JP-A-2007-2220, columns 0040-0063.

The compounds may be prepared according to any process. For example, the compounds may be prepared according to the method described in JP-A-2007-2220, columns 0064-0070.

The liquid-crystal phase that the liquid-crystal compound to be used in the invention expresses includes a columnar phase and a discotic nematic phase (ND phase). Of those liquid-crystal phases, preferred is a discotic nematic phase (ND phase) having a good mono-domain property.

Among the discotic liquid crystal compounds, the compounds forming the liquid crystal phase at a temperature of from 20 degrees Celsius to 300 degrees are preferable. The compounds forming the liquid crystal phase at a temperature of from 40 degrees Celsius to 280 degrees are more preferable, and the compounds forming the liquid crystal phase at a temperature of from 60 degrees Celsius to 250 degrees are even more preferable. The compound forming the liquid crystal phase at a temperature of 20 degrees Celsius to 300 degrees Celsius includes any compound of which the temperature range forming the liquid crystal phase resides including 20 degrees Celsius (for example the temperature range is from 10 degrees Celsius to 22 degrees Celsius), and includes also any compound of which the temperature range forming the liquid crystal phase resides including 300 degrees Celsius (for example, the temperature range is from 298 degrees Celsius to 310 degrees Celsius). The same will be applied to the temperature ranges of from 40 degrees Celsius to 280 degrees Celsius and of from 60 degrees Celsius to 250 degrees Celsius.

The discotic liquid crystal represented by formula (IV) having plural aromatic rings may interact with the pyridinium or imidazolium compound described later via the intermolecular n-n interaction, which may increase the tilt angle of the discotic liquid crystal in the area neighboring to the alignment layer. Especially, the discotic liquid crystal represented by formula (IV′) in which plural aromatic rings or heterocyclic rings are connected via a single bond to each other may keep the linearity of the molecule thereof since the free rotation of the bonding may be restricted strongly by the linking group. Therefore, the discotic liquid crystal represented by formula (IV′) having plural aromatic rings may interact with the pyridinium or imidazolium compound via the stronger intermolecular n-n interaction, which may increase the tilt angle of the discotic liquid crystal more remarkably in the area neighboring to the alignment layer to achieve the vertical alignment.

According to the embodiment employing any rod-like liquid crystal compound, it is preferable that the rod-like liquid crystal is aligned horizontally. It is to be understood that the term “horizontal alignment” in the specification means that the direction of long axis of a liquid crystalline molecule is parallel to the layer plane, wherein strict parallelness is not always necessary; and means, in this specification, that a tilt angle of the mean direction of long axes of liquid crystalline molecules with respect to the horizontal plane is smaller than 10°. The tilt angle is preferably from 0 to 5°, more preferably from 0 to 3°, even more preferably from 0 to 2°, or most preferably from 0 to 1°.

The composition preferably contains an additive capable of promoting the horizontal alignment of the liquid crystal, and examples of the additive include those described in JPA-2009-223001, columns 0055-0063.

According to the embodiment employing any discotic liquid crystal compound, it is preferable that the discotic liquid crystal is aligned vertically. It is to be understood that the term “vertical alignment” in the specification means that the discotic plane of the discotic liquid crystal is vertical to the layer plane, wherein strict verticalness is not always necessary; and means, in this specification, that a tilt angle of liquid crystalline molecules with respect to the horizontal plane is equal to or larger than 70°. The tilt angle is preferably from 85 to 90°, more preferably from 87 to 90°, even more preferably from 88 to 90°, or most preferably from 89 to 90°.

The composition preferably contains an additive capable of promoting the vertical alignment, and examples of the additive are described above.

It is difficult to accurately and directly measure θ1, which is a tilt angle at a surface of an optically-anisotropic film (an angle between the physical symmetric axis of a discotic or rod-like liquid-crystal molecule in the optically-anisotropic film and an interface of the layer), and θ2, which is a tilt angle at another surface of the optically-anisotropic film. Therefore, in this description, θ1 and θ2 are calculated as follows: This method could not accurately express the actual alignment state, but may be helpful as a means for indicating the relative relationship of some optical characteristics of an optical film.

In this method, the following two points are assumed for facilitating the calculation, and the tilt angles at two interfaces of an optically-anisotropic film are determined.

1. It is assumed that an optically-anisotropic film is a multi-layered structure that comprises a layer containing discotic or rod-like compound(s). It is further assumed that the minimum unit layer constituting the structure (on the assumption that the tilt angle of the liquid crystal compound molecule is uniform inside the layer) is an optically-monoaxial layer.

2. It is assumed that the tilt angle in each layer varies monotonously as a linear function in the direction of the thickness of an optically-anisotropic layer.

A concrete method for calculation is as follows:

(1) In a plane in which the tilt angle in each layer monotonously varies as a linear function in the direction of the thickness of an optically-anisotropic film, the incident angle of light to be applied to the optically-anisotropic film is varied, and the retardation is measured at three or more angles. For simplifying the measurement and the calculation, it is desirable that the retardation is measured at three angles of −40°, 0° and +40° relative to the normal direction to the optically-anisotropic film of being at an angle of 0°. For the measurement, for example, used are KOBRA-21ADH and KOBRA-WR (by Oji Scientific Instruments), and transmission ellipsometers AEP-100 (by Shimadzu), M150 and M520 (by Nippon Bunko) and ABR10A (by Uniopto).

(2) In the above model, the refractive index of each layer for normal light is represented by n0; the refractive index thereof for abnormal light is by ne (ne is the same in all layers as well as n0); and the overall thickness of the multi-layer structure is represented by d. On the assumption that the tilting direction in each layer and the monoaxial optical axis direction of the layer are the same, the tilt angle θ1 in one face of the optically-anisotropic layer and the tilt angle θ2 in the other face thereof are fitted as variables in order that the calculated data of the angle dependence of the retardation of the optically-anisotropic layer could be the same as the found data thereof, and θ1 and θ2 are thus calculated.

In this, n0 and ne may be those known in literature and catalogues. When they are unknown, they may be measured with an Abbe's refractiometer. The thickness of the optically-anisotropic film may be measured with an optical interference thickness gauge or on a photograph showing the cross section of the layer taken by a scanning electronic microscope.

### [Onium Salt Compound (Agent for Controlling Alignment at Alignment Layer)]

According to the present invention, any onium salt compound is preferably added for achieving the vertical alignment of the liquid crystal compound having the polymerizable group, or especially, the discotic liquid crystal having the polymerizable group. The onium salt may localize at the alignment layer interface, and may function to increase the tilt angles of the liquid crystal molecules in the area neighboring to the alignment layer

As the onium salt compound, the compound represented by formula (1) is preferable.

Z—(Y-L-)ₙCy⁺.X⁻ Formula (1)

In the formula, Cy represents a 5-membered or 6-membered cyclic onium group; the definitions of L, Y, Z and X are same as those of L²³, L²⁴, Y²², Y²³, Z²¹ and X in formula (2a) or (2b) described later, and these preferable examples are same as those of them in formula (2a) or (2b); and n represents an integer of equal to or more than 2.

The 5-membered or 6-membered onium group (Cy) is preferably pyrazolium ring, imidazolium ring, triazolium ring, tetrazolium ring, pyridium ring, pyrimidinium ring or triazinium ring, or more preferably imidazolium ring or pyridinium ring.

The 5- or 6-membered onium group (Cy) preferably has a group affinity with the material of the alignment layer. Preferably, the onium salt compound has the high affinity with the material of the alignment layer at a temperature of T₁ degrees Celsius, and the onium salt compound exhibits the low affinity with the material of the alignment layer at a temperature of T₂ degrees Celsius. The hydrogen bonding can become both of the bonding state and the non-bonding state within the temperature range (room temperature to 150 degrees Celsius) within which the liquid crystal may be aligned, and therefore, the affinity due to the hydrogen bonding is preferably used. However, the invention is not limited to the embodiment using the affinity due to the hydrogen bonding.

For example, according to the embodiment employing the polyvinyl alcohol as a material of the alignment layer, the onium salt preferably has the group which is capable of forming the hydrogen bonding to form the hydrogen bonding with a hydroxy group of the polyvinyl alcohol. The theoretical interpretation of the hydrogen bonding is reported, for example, in Journal of American Chemical Society, vol. 99, pp. 1316-1332, 1977, H. Uneyama and K. Morokuma. The concrete modes of the hydrogen bonding are exemplified in FIG. 17 on page 98 described in “Intermolecular and Surface Forces (Bunshikanryoku to Hyoumenn Chohryoku)” written by Jacob Nissim Israelachvili, translated in Japanese by Tamotsu Kondoh and Hiroyuki Ohshima, and published by McGraw-Hill Company in 1991. Examples of the hydrogen bonding include those described in Angewante Chemistry International Edition English, col. 34, 00.2311, 1955, G. R. Desiraju.

The 5-membered or 6-membered cyclic onium group having a hydrogen bonding group may increase the localization at the alignment layer interface and promote the orthogonal alignment with respect to the main chain of the polyvinyl alcohol by the hydrogen bonding with the polyvinyl alcohol along with the affinity effect of the onium group. Preferable examples of the hydrogen bonding group include an amino group, carbamide group, sulfonamide group, acid amide group, ureido group, carbamoyl group, carboxyl group, sulfo group, nitrogen-containing heterocyclic group (such as imidazolyl group, benzimidazolyl group pyrazolyl group, pyridyl group, 1,3,5-triazyl group, pyrimidyl group, pyridazyl group, quinonyl group, benzoimidazolyl group, benzothiazolyl, succinimide group, phthalimide group, maleimide group, uracil group, thiouracil group, barbituric acid group, hydantoin group, maleic hydrazide group, isatin group, and uramil group). More preferable examples of the hydrogen bonding include an amino group and pyridyl group.

For example, as well as an imidazolium ring in which a nitrogen atom having a group capable of forming the hydrogen bonding is embedded, the 5-membered or 6-membered onium ring in which any atom(s) having a group capable of forming the hydrogen bonding is embedded is also preferable.

In the formula, n is preferably an integer of from 2 to 5, more preferably 3 or 4, or most preferably 3. Plural L and Y may be same or different from each other respectively. The onium salt represented by formula (I) in which n is not smaller than 3 has 3 or more numbers of the 5-membered or 6-membered rings, may interact with the discotic liquid crystal by the intermolecular n-n interaction, and, especially on the polyvinyl-alcohol alignment layer, can achieve the orthogonal-vertical alignment with respect to the polyvinyl-alcohol main chain.

The onium salt represented by formula (I) is preferably selected from the pyridinium compounds represented by formula (2a) or the imidazolium compounds represented by formula (2b).

The compound represented by formula (2a) or (2b) may mainly be added to the discotic liquid crystal represented by any one of the formulas (I)-(IV) for controlling the alignment of the liquid crystal compound at the alignment layer interface, and may have a function of increasing the tilt angles of the discotic liquid crystal molecules in the area neighboring to the alignment layer interface.

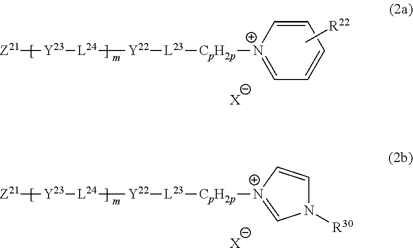

In the formula, L²³ and L²⁴ represent a divalent linking group respectively.

L²³ is preferably a single bond, —O—, —O—CO—, —CO—O—, —C≡C—, —CH═CH—, —CH═N—, —N═CH—, —N═N—, —O-AL-O—, —O-AL—O—CO—, —O-AL-CO—O—, —CO—O-AL-O—, —CO—O-AL—O—CO—, —CO—O-AL—CO—O—, —O—CO-AL-O—, —O—CO-AL-O—CO— or —O—CO-AL-CO—O—, and AL is a C₁₋₁₀ alkylene group. L²³ is more preferably a single bond, —O—, —O-AL-O—, —O-AL—O—CO—, —O-AL—CO—O—, —CO—O-AL-O—, —CO—O-AL—O—CO—, —CO—O-AL-CO—O—, —O—CO-AL-O—, —O—CO-AL-O—CO— or —O—CO-AL—CO—O—, even more preferably a single bond or —O—, or most preferably —O—.

L²⁴ is preferably a single bond, —O—, —O—CO—, —CO—O—, —C≡C—, —CH═CH—, —CH═N—, —N═CH— or —N═N—, or more preferably —O—CO— or —CO—O—. If n is equal to or larger than 2, a plurality of L²⁴ preferably represents —O—CO— or —CO—O— alternately.

R²² represents a hydrogen atom, unsubstituted amino group or substituted C₁₋₂₀ amino group.

If R²² is a dialkyl-substituted amino group, the two alkyls may connect to each other to form a nitrogen-containing heterocyclic ring. The nitrogen-containing heterocyclic ring is preferably a 5-membered or 6-membered ring. R²² preferably represents a hydrogen atom, non-substituted amino group or C₂₋₁₂ dialkyl substituted amino group, or even more preferably, a hydrogen atom, non-substituted amino group or C₂₋₈ dialkyl substituted amino group. If R²² is a non-substituted or substituted amino group, the 4-position of the pyridinium is preferably substituted.

X represents an anion.

X preferably represents a monovalent anion. Examples of the anion include halide ion (such as fluorine ion, chlorine ion, bromine ion and iodide ion) and sulfonic acid ions (such as methane sulfonate ion, p-toluene sulfonate ion and benzene sulfonate ion).

Y²² and Y²³ represent a divalent linking group having a 5-membered or 6-membered ring as a part structure respectively.

The 5-membered or 6-membered ring may have at least one substituent. Preferably, at least one of Y²² and Y²³ is a divalent linking group having a 5-membered or 6-membered ring with at least one substituent as a part structure. Preferably, Y²² and Y²³ each independently represent a divalent linking group having a 6-membered ring, which may have at least one substituent, as a part structure. The 6-membered ring includes an alicyclic ring, aromatic ring (benzene ring) and heterocyclic ring. Examples of the 6-membered alicyclic ring include a cyclohexane ring, cyclohexane ring and cyclohexadiene ring. Examples of the 6-membered heterocyclic ring include pyrane ring, dioxane ring, dithiane ring, thiin ring, pyridine ring, piperidine ring, oxazine ring, morpholino ring, thiazine ring, pyridazine ring, pyrimidine ring, pyrazine ring, piperazine ring and triazine ring. Other 6-membered or 5-membered ring(s) may be condensed with the 6-membered ring.

Examples of the substituent include halogen atoms, cyano, C₁₋₁₂ alkyls and C₁₋₁₂ alkoxys. The alkyl or alkoxy may have at least one C₂₋₁₂ acyl or C₂₋₁₂ acyloxy. The substituent is preferably selected from C₁₋₁₂ (more preferably C₁₋₆, even more preferably C₁₋₃) alkyls. The 5-membered or 6-membered ring may have two or more substituents. For example, if Y²² and Y²³ are phenyls, they may have from 1 to 4 C₁₋₁₂ (more preferably C₁₋₆, or even more preferably C₁₋₃) alkyls.

In the formula, m is 1 or 2, or is preferably 2. If m is 2, plural Y²³ and L²⁴ may be same or different from each other respectively.

In the formula, Z²¹ is a monovalent group selected from the group consisting of a halogen-substituted phenyl, nitro-substituted phenyl, cyano-substituted phenyl, C₁₋₁₀ alkyl-substituted phenyl, C₂₋₁₀ alkoxy-substituted phenyl, C₁₋₁₂ alkyl, C₂₋₂₀ alkynyl, C₁₋₁₂ alkoxy, C₂₋₁₃ alkoxycarbonyl, C₇₋₂₆ aryloxycarbonyl and C₇₋₂₆ arylcarbonyloxy.

If m is 2, Z²¹ is preferably cyano, a C₁₋₁₀ alkyl or aC₁₋₁₀ alkoxy, or more preferably a C₄₋₁₀ alkoxy.

If m is 1, Z²¹ is preferably a C₇₋₁₂ alkyl, C₇₋₁₂ alkoxy, C₇₋₁₂ acyl-substituted alkyl, C₇₋₁₂ acyl-substituted alkoxy, C₇₋₁₂ acyloxy-substituted alkyl or C₇₋₁₂ acyloxy-substituted alkoxy.

The acyl is represented by —CO—R, the acyloxy is represented by —O—CO—R, and R represents an aliphatic group (including alkyl, substituted alkyl, alkenyl, substituted alkenyl, alkynyl and substituted alkynyl), or an aromatic group (including aryl and substituted aryl). R is preferably an aliphatic group, or more preferably an alkyl or alkenyl.

In the formula, p is an integer of from 1 to 10, or preferably 1 or 2. CₚH₂ₚ represents an alkylene chain which may have a branched structure. CₚH₂ₚ is preferably a linear alkylene chain (—(CH₂)ₚ—).

In formula (2b), R³⁰ represents a hydrogen atom or a C₁₋₁₂ (preferably C₁₋₆, or more preferably C₁₋₃) alkyl group.

Among the compounds represented by formula (2a) or (2b), the compound represented by formula (2a′) or (2′) is preferable.

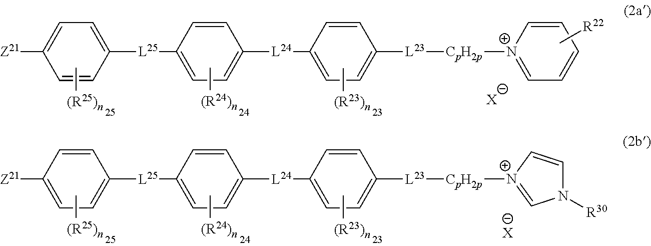

Among the symbols in the formula (2a′) or (2b′), the same symbols have the same definition as those found in formula (2), and preferable examples thereof are same as those in formula (2). Preferably, L²⁴ and L²⁵ represent —O—CO— or —CO—O—; or more preferably, L²⁴ is —O—CO— and L²⁵ is —CO—O—.

R²³, R²⁴ and R²⁵ represent a C₁₋₁₂ (more preferably C₁₋₆, or even more preferably C₁₋₃) alkyl respectively. In the formula, n₂₃ is from 0 to 4, n₂₄ is from 1 to 4, and n₂₅ is from 0 to 4. Preferably, n₂₃ and n₂₅ are 0, and n₂₄ is from 1 to 4 (more preferably from 1 to 3).

Preferably, R³⁰ represents a C₁₋₁₂ (more preferably C₁₋₆, or even more preferably C₁₋₃) alkyl.

Examples of the compound represented by formula (I) include those described in JP-A-2006-113500, columns [0058]-[0061].

Specific examples of the compound represented by formula (2′) include, but are not limited to, those shown below. Description of the anion (X⁻) is omitted.

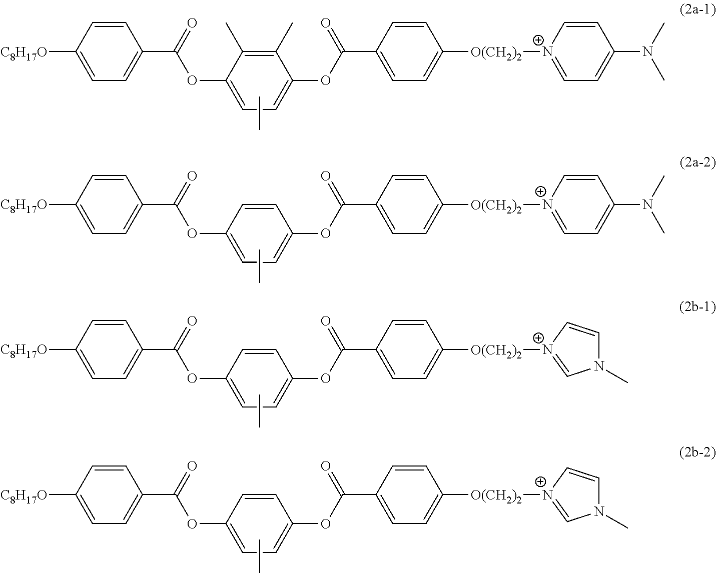

The compound represented by formula (2a) or (2b) may be prepared according to a usual method. For example, usually, the pyridinium derivative may be prepared according to the method wherein a pyridine ring is subjected to an alkylation (Menschutkin reaction).

An amount of the onium salt may be not more than 5% by mass, or preferably about 0.1 to about 2% by mass, with respect to an amount of the liquid crystal compound.

The onium salt represented by formula (2a) or (2b) may localize at the surface of the hydrophilic polyvinyl alcohol alignment layer since the pyridinium or imidazolium group is hydrophilic. Especially, the pyridinium group, or the pyridinium group, having an amino which is an acceptor of a hydrogen atom (in formula (2a) or (2a′), R²² is a non-substituted amino or C₁₋₂₀ substituted amino), may form an intermolecular hydrogen bonding with the polyvinyl alcohol, may localize at the surface of the alignment layer densely, and may promote the orthogonal alignment of the liquid crystal with respect to the rubbing direction along with the pyridinium derivative, which is aligned along the direction orthogonal to the polyvinyl alcohol main chain, by the effect of the hydrogen bonding. The pyridinium derivative having plural aromatic rings may interact with the liquid crystal, especially discotic liquid crystal, by the strong intermolecular n-n interaction, and may induce the orthogonal alignment of the discotic liquid crystal in the area neighboring to the alignment layer. Especially, as represented by formula (2a′), the compound in which the hydrophilic pyridinium group is connected with the hydrophobic aromatic ring may have an effect of inducing the vertical alignment by the hydrophobic property.

Furthermore, in the embodiment using also the onium salt represented by formula (2a) or (2b), the horizontal alignment state in which the liquid crystal is aligned so that the slow axis thereof is parallel to the rubbing direction may be promoted when being applied with heat over a certain temperature. This may be because the hydrogen bonding with the polyvinyl alcohol would be broken by the thermal energy caused by heating, the onium salt would be dispersed uniformly, the density of the onium salt at the surface of the alignment layer would be lowered, and the liquid crystal would be aligned by the alignment controlling force of the rubbed alignment layer itself

[Fluoroaliphatic Group-Containing Copolymer (Agent for Controlling Alignment at Air-Interface)]

The fluoroaliphatic group-containing copolymer may be added to the liquid crystal for controlling the alignment of the discotic liquid crystal represented by formula (I) at the air-interface, and may have a function of increasing the tilt angles of the liquid crystal molecules in the area neighboring to the air interface. And the copolymer may also have a function of improving the coating properties such as unevenness or repelling.

Examples of the fluoroaliphatic group-containing copolymer which can be used in the present invention include those described in JP-A-2004-333852, JP-A-2004-333861, J-PA-2005-134884, JP-A-2005-179636, and JP-A-2005-181977. The polymers having a fluoroaliphatic group and at least a hydrophilic group selected from the group consisting of carboxyl (—COOH), sulfo (—SO₃H), phosphonoxy {—OP(═O) (OH)₂)} and any salts thereof, described in JP-A-2005-179636 and JP-A-2005-181977 are preferable.

An amount of the fluoroaliphatic group-containing copolymer is less than 2% by mass, or preferably from 0.1 to 1% by mass with respect to an amount of the liquid crystal compound.

The fluoroaliphatic group-containing copolymer may localize at the air-interface by The hydrophobic effect of the fluoroaliphatic group, and may provide the low-surface energy area at the air-interface, and the tilt angle of the liquid crystal compound, especially discotic liquid crystal compound, in the area may be increased. Furthermore, by using the copolymer having the hydrophilic group selected from the group consisting of carboxyl (—COOH), sulfo (—SO₃H), phosphonoxy {—OP(═O) (OH)₂)} and any salts thereof, the vertical alignment of the liquid crystal may be achieved by the charge repulsion between the anion of the copolymer and the n electrons of the liquid crystal.

[Solvent]

The composition to be used for preparing the optically anisotropic layer is preferably prepared as a coating liquid.

Organic solvents are preferably used as the solvent used for preparing the coating liquid. Examples of the organic solvents include amides (e.g., N,N-dimethylformamide), sulfoxides (e.g., dimethylsulfoxide), heterocyclic compounds (e.g., pyridine), hydrocarbons (e.g., benzene, hexane), alkyl halide (e.g., chloroform, dichloromethane), esters (e.g., methyl acetate, butyl acetate), ketones (e.g., acetone, methyl ethyl ketone), and ethers (e.g., tetrahydrofuran, 1,2-dimethoxyethane). Alkyl halides and ketones are preferable. Two or more species of organic solvent can be combined.

### [Polymerization Initiator]

The composition (for example coating liquid) containing the liquid crystal having the polymerizable group(s) is aligned in any alignment state, and then, the alignment state is preferably fixed via the polymerization thereof in the above-described the e and g process). The fixation is preferably carried out by polymerization reaction between the polymerizable groups introduced into the liquid crystalline compound. Examples of the polymerization reaction include thermal polymerization reaction using a thermal polymerization initiator, and photo-polymerization reaction using a photo-polymerization initiator, wherein photo-polymerization reaction is more preferable. Examples of the photo-polymerization initiator include α-carbonyl compounds (those described in U.S. Pat. Nos. 2,367,661 and 2,367,670), acyloin ethers (those described in U.S. Pat. No. 2,448,828), α-hydrocarbon-substituted aromatic acyloin compounds (those described in U.S. Pat. No. 2,722,512), polynuclear quinone compounds (those described in U.S. Pat. Nos. 3,046,127 and 2,951,758), combinations of triarylimidazole dimer and p-aminophenyl ketone (those described in U.S. Pat. No. 3,549,367), acrydine and phenazine compounds (those described in Japanese Laid-Open Patent Publication No. S60-105667 and U.S. Pat. No. 4,239,850), and oxadiazole compounds (those described in U.S. Pat. No. 4,212,970). Examples of the cationic photo-polymerization initiator include organic sulfonium salts, iodonium salts and phosphonium salts, organic solfonium salts are preferable, and triphenyl sulfonium salts are especially preferable. Preferable examples of the counter ion thereof include hexafluoro antimonate and hexafluoro phosphate.

An amount of the photo-polymerization initiator to be used is preferably from 0.01 to 20% by mass, or more preferable from 0.5 to 5% by mass, with respect to the solid content of the coating liquid.

[Sensitizer]

For enhancing the sensitivity, any sensitizer may be used along with the polymerization initiator. Examples of the sensitizer include n-butyl amine, triethyl amine, tri-n-butyl phosphine and thioxanthone. The photo-polymerization initiator may be used in combination with other photo-polymerization initiator(s). An amount of the photo-polymerization initiator is preferably from 0.01 to 20% by mass, or more preferably from 0.5 to 5% by mass, with respect to the solid content of the coating liquid. For carrying out the polymerization of the liquid crystal compound, an irradiation with UV light is preferably performed.

### [Other Additives]

The composition may contain any polymerizable non-liquid-crystal monomer(s) along with the polymerizable liquid crystal compound. Preferable examples of the polymerizable monomer include any compounds having vinyl, vinyloxy, acryloyl or methacryloyl. Using any multi-functional monomer, having two or more polymerizable groups, such as ethylene oxide modified trimethylolpropane acrylate may contribute to improving the durability, which is preferable. An amount of the non-liquid-crystal polymerizable monomer to be used is preferably less than 40% by mass, or more preferably from 0 to 20% by mass, with respect to the amount of the liquid crystal compound.

The thickness of the optically anisotropic layer is not limited, and preferably from 0.1 to 10 micro meters, or more preferably from 0.5 to 5 micro meters.

Transparent Support:

The optical film of the invention has a transparent support that supports the above-mentioned optically-anisotropic layer. As the transparent support, preferred is use of a polymer film having positive Rth. As the transparent support, also preferred is use of a polymer film having low Re and low Rth.

The material for forming the transparent support usable in the invention includes, for example, polycarbonate polymers; polyester polymers such as polyethylene terephthalate, polyethylene naphthalate, etc.; acrylic polymers such as polymethyl methacrylate, etc.; styrenic polymers such as polystyrene, acrylonitrile/styrene copolymer (AS resin), etc. As other examples of the material usable herein, also mentioned are polyolefins such as polyethylene, polypropylene, etc.; polyolefinic polymers such as ethylene/propylene copolymer, etc.; vinyl chloride polymers; amide polymers such as nylon, aromatic polyamides, etc.; imide polymers; sulfone polymers; polyether sulfone polymers; polyether ether ketone polymers; polyphenylene sulfide polymers; vinylidene chloride polymers; vinyl alcohol polymers; vinylbutyral polymers; arylate polymers, polyoxymethylene polymers; epoxy polymers; mixed polymers prepared by mixing the above-mentioned polymers. The polymer film in the invention may be formed as a cured layer of a UV-curable or thermocurable resin such as acrylic, urethane, acrylurethane, epoxy, silicone or the like resins.

As the material for forming the transparent support, also preferred is use of thermoplastic norbornene resins. As the thermoplastic norbornene resins, there are mentioned Nippon Zeon's Zeonex and Zeonoa; JSR's Arton, etc.

Preferable examples of the material, constituting the transparent support, include also cellulose series polymers (occasionally referred to as cellulose acylate hereinafter) such as cellulose triacetate used as a transparent protective film of a polarizing plate conventionally.

Cellulose acylate will be mainly described in details as an example of the material of the transparent support. However, the technical matters of the cellulose acylate film described under may be applied to other polymer films.

The starting cellulose for the cellulose acylate includes cotton linter and wood pulp (hardwood pulp, softwood pulp), etc.; and any cellulose acylate obtained from any starting cellulose can be used herein. As the case may be, different starting celluloses may be mixed for use herein. The starting cellulose materials are described in detail, for example, in “Plastic Material Lecture (17), Cellulosic Resin” (written by Marusawa & Uda, published by Nikkan Kogyo Shinbun, 1970), and in Hatsumei Kyokai Disclosure Bulletin No. 2001-1745, pp. 7-8. Any cellulose material described in these can be used here with no specific limitation.

The cellulose acylate for use in the invention is, for example, one prepared from cellulose by acylating the hydroxyl group therein, in which the substituent for acylation may be any acyl group having from 2 to 22 carbon atoms. The degree of substitution of the hydroxyl group in cellulose for the cellulose acylate for use in the invention is not specifically defined. The bonding degree with acetic acid and/or a fatty acid having from 3 to 22 carbon atoms for substituting the hydroxyl group in cellulose is measured, and the degree of substitution in the cellulose acylate may be determined through computation. For the measurement, the method of ASTM D-817-91 may be employed.

In the cellulose acylate, the degree of substitution of the hydroxyl group in cellulose is not specifically defined, but preferably, the degree of acyl substitution of the hydroxyl group in cellulose is from 2.50 to 3.00, more preferably from 2.75 to 3.00, even more preferably from 2.85 to 3.00.

The acyl group having from 2 to 22 carbon atoms, which is in acetic acid and/or the fatty acid having from 3 to 22 carbon atoms and which is to substitute for the hydroxyl group in cellulose may be an aliphatic group or an aryl group, and may be a single group or a mixture of two or more different groups. For example, there may be mentioned cellulose alkylcarbonyl esters, alkenylcarbonyl esters, aromatic carbonyl esters, aromatic alkylcarbonyl esters, etc. These may be further substituted. Preferred examples of the acyl group in these include an acetyl group, a propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an iso-butanoyl group, a tert-butanoyl group, a cyclohexanecarbonyl group, an oleoyl group, a benzoyl group, a naphthylcarbonyl group, a cinnamoyl group, etc. Of those, preferred are an acetyl group, a propionyl group, a butanoyl group, a dodecanoyl group, an octadecanoyl group, a tert-butanoyl group, an oleoyl group, a benzoyl group, a naphthylcarbonyl group a cinnamoyl group, etc.; and more preferred are an acetyl group, a propionyl group, and a butanoyl group.

In case where the acyl substituent to substitute for the hydroxyl group of cellulose mentioned above comprises at least two of an acetyl group, a propionyl group and a butanoyl group, the degree of total substitution with the substituents is preferably from 2.50 to 3.00 as capable of lowering the optical anisotropy of the cellulose acylate film. More preferably, the degree of acyl substitution is from 2.60 to 3.00, even more preferably from 2.65 to 3.00. Or in case where the acyl substituent to substitute for the hydroxyl group of cellulose mentioned above is only an acetyl group, the degree of total substitution with the substituents is preferably from 2.80 to 2.99 as not only capable of lowering the optical anisotropy of the cellulose acylate film but also capable of improving the compatibility with other additive(s) and the solubility in the organic solvent. More preferably, the degree of acetyl substitution is from 2.85 to 2.95.

Regarding the degree of polymerization of the cellulose acylate to be used here as the starting material, preferably, the viscosity-average degree of polymerization is from 180 to 700. More preferably, the viscosity-average degree of polymerization of cellulose acetate is from 180 to 550, even more preferably from 180 to 400, still more preferably from 180 to 350. When the degree of polymerization is not higher than a predetermined level, then the viscosity of the dope solution of cellulose acylate may be prevented from increasing too much and the film formation by casting may be effectively prevented from becoming difficult. When the degree of polymerization is not lower than a predetermined level, then the strength of the formed film may be effectively prevented from lowering. The degree of polymerization may be measured, for example, according to Uda et al's limiting viscosity method (Kazuo Uda, Hideo Saito, Sen'i Gakkaishi by the Society of Fiber Science and Technology, Japan, Vol. 18, No. 1, pp. 105-120, 1962). The method is described in detail in JP-A 9-95538.

The molecular weight distribution of the cellulose acylate preferably used here as the starting material can be evaluated through gel permeation chromatography, and the polydispersity index Mw/Mn (Mw: mass-average molecular weight, Mn: number-average molecular weight) thereof is preferably smaller, or that is, the molecular weight dispersion thereof is preferably narrower. Concretely, the value of Mw/Mn is preferably from 1.0 to 3.0, more preferably from 1.0 to 2.0, even more preferably from 1.0 to 1.6.

When the low-molecular component is removed, the mean molecular weight (degree of polymerization) may increase but the viscosity could be lower than that of ordinary cellulose acylate, and therefore the case is favorable here. The cellulose acylate in which the content of the low-molecular component is low may be prepared by removing the low-molecular component from cellulose acylate produced according to an ordinary method. The low-molecular component may be removed by washing the cellulose acylate with a suitable organic solvent. In case where the cellulose acylate in which the content of the low-molecular component is low is produced, preferably, the amount of the sulfuric acid catalyst in acetylation is controlled to be from 0.5 to 25 parts by mass relative to 100 parts by mass of cellulose. When the amount of the sulfuric acid catalyst is controlled to fall within the above range, a cellulose acylate favorable in point of the molecular weight distribution thereof (that is, having a uniform molecular weight distribution) can be produced. Preferably, the water content of the cellulose acylate for use in the invention is at most 2% by mass, more preferably at most 1% by mass, even more preferably at most 0.7% by mass. In general, cellulose acylate contains water, and it is known that the water content thereof is from 2.5 to 5% by mass. In order to control the water content of cellulose acylate to fall within the above range, the cellulose acylate must be dried, and the method for drying is not specifically defined so far as the dried cellulose acylate could have the intended water content. The starting cotton and the production method for the cellulose acylate satisfying the above-mentioned various characteristics are described in detail in Hatsumei Kyokai Disclosure Bulletin No. 2001-1745 (published on Mar. 15, 2001 by Hatsumei Kyokai) pp. 7-12.

As the starting material for the cellulose acylate film, preferably used is a single cellulose acylate or a mixture of two or more different types of cellulose acylates of which the substituent, the degree of substitution, the degree of polymerization and the molecular weight distribution each fall within the above-mentioned range.

The cellulose acylate film can be produced according to a solution casting method. To the cellulose acylate solution (dope), various additives (e.g., compound capable of lowering the optical anisotropy, wavelength dispersion characteristics-controlling agent, fine particles, plasticizer, UV inhibitor, antioxidant, separating agent, optical characteristics-controlling agent, etc.) may be added in accordance with the use thereof in the production process. The additive may be added in any stage of the dope production process. The additive may be added at the end of the dope production process.

By adjusting the amount of the additive(s), it is possible to prepare a cellulose acylate film satisfying the condition of 0 nm≦Re (550)≦10 nm. And by using such the cellulose acylate film as a support, it is possible to adjust Re of the first and the second retardation areas to the range of 110 nm≦Re (550)≦165 nm. The Re value preferably satisfies 120 nm≦Re (550)≦145 nm, or more preferably satisfies 130 nm≦Re (550)≦145 nm. In the relation with the optically anisotropic layer described later, the support preferably satisfies the condition of −150 nm≦Rth(630)≦100 nm for satisfying the condition that the total Rth of the transparent support and the optically anisotropic layer (λ/4 plate) satisfies the condition of |Rth|≦20 nm.

According to a preferable embodiment, the cellulose acylate film contains at least one compound capable of lowering the optical anisotropy.

The compound capable of lowering the optical anisotropy of the cellulose acylate film will be described in details. The compound capable of lowering the optical anisotropy is preferably selected from the compounds which are compatible with the cellulose acylate sufficiently and have neither any rod-like structure nor any planer structure. More specifically, if the compound has plural planar functional groups such as an aromatic group, it is preferable that the functional groups reside in the planes different from each other rather than in the same plane.

For preparing the cellulose acylate film having low retardation, the compound, as the compound capable of preventing the orientation of cellulose acylate in the film to thereby lower the optical anisotropy of the film, preferred for use herein is a compound having an octanol-water partition coefficient (log P value) of from 0 to 7. When a compound having a log P value of at most 7 is used, then the compound is more miscible with cellulose acylate and the film can be effectively prevented from being cloudy and chalky. When a compound having a log P value of at least 0 is used, then the compound is highly hydrophilic and therefore can more effectively prevent the waterproofness of the cellulose acylate film from lowering. More preferably, the log P value is from 1 to 6, even more preferably from 1.5 to 5.

The octanol-water partition coefficient (log P value) can be measured according to a flask dipping method described in JIS (Japanese Industrial Standards) Z7260-107 (2000). In place of actually measuring it, the octanol-water partition coefficient (log P value) may be estimated according to a calculative chemical method or an experiential method. For the calculative method, preferred are a Crippen's fragmentation method (J. Chem. Inf. Comput. Sci., 27, 21 (1987)), a Viswanadhan's fragmentation method (J. Chem. Inf. Comput. Sci., 29, 163 (1989)), a Broto's fragmentation method (Eur. J. Med. Chem.—Chim. Theor., 19, 71 (1984)); and more preferred is a Crippen's fragmentation method (J. Chem. Inf. Comput. Sci., 27, (1987)). When a compound has different log P values, depending on the measuring method or the computing method employed, then the compound may be determined as to whether or not it falls within the scope of the invention preferably according to the Crippen's fragmentation method. The Log P value described in the specification is calculated according to the Crippen's fragmentation method (J. Chem. Inf. Comput. Sci., 27,21 (1987).).

The compound capable of lowering the optical anisotropy may or may not have an aromatic compound. Preferably, the compound capable of lowering the optical anisotropy has a molecular weight of from 150 to 3000, more preferably from 170 to 2000, even more preferably from 200 to 1000. Having a molecular weight that falls within the range. The compound may have a specific monomer structure or may have an oligomer structure or a polymer structure that comprises a plurality of such monomer units bonded.

The compound capable of lowering the optical anisotropy is preferably liquid at 25 degrees Celsius or a solid having a melting point of from 25 to 250 degrees Celsius, more preferably liquid at 25 degrees Celsius or a solid having a melting point of from 25 to 200 degrees Celsius. Also preferably, the compound capable of lowering the optical anisotropy does not vaporize in the process of dope casting and drying for cellulose acylate film formation.

An amount to be added of the compound capable of lowering the optical anisotropy is preferably from 0.01 to 30% by mass, more preferably from 1 to 25% by mass, or even more preferably from 5 to 20% by mass, with respect to the amount of the cellulose acylate.

The compound capable of lowering the optical anisotropy may be used either singly or as a mixture of two or more different types of such compounds combined in any desired ratio.

The compound capable of lowering the optical anisotropy may be added at any time during the preparation of the dope, and may be added at the end of the step for preparing the dope.

Regarding the content of the optical anisotropy-lowering compound in the cellulose acylate film, preferably, the mean content of the compound in the part of 10% of the overall thickness from the surface of at least one side of the film is from 80 to 99% of the mean content of the compound in the center part of the film. An amount of the optical anisotropy-lowering compound existing in the film may be determined by measuring the amount of the compound in the surface area and in the center part of the film, according to a method of infrared spectrometry as in JP-A 8-57879.

Specific examples of compound capable of lowering the optical anisotropy of cellulose acylate film are described in JP-A 2006-199855, columns 0035-0058, and are employable in the invention, to which, however, the invention is not limited.

The optical film of the present invention may be disposed at the viewed side, and may be influenced easily by the outside light, especially UV rays. Therefore, any ultraviolet (UV) absorber is preferably added to the polymer film or the like to be used as a transparent support.

Among the UV absorbers, the compound which has the absorbability for the UV rays within the wavelength range of from 200 to 400 nm and is capable of lowering both of the values of |Re(400)−Re(700)| and |Rth(400)−Rth(700)| is preferable. An amount of the compound to be used is preferably from 0.01 to 30% by mass.

According to the liquid crystal display device such as TV, notebook computers and mobile phones, the optical members to be used in the liquid crystal display device are required to be excellent in transparency for raising the brightness with smaller electricity consumption. From this viewpoint, the cellulose acylate containing the compound, which has the absorbability for the UV rays within the wavelength range of from 200 to 400 nm and is capable of lowering both of the values of |Re(400)−Re(700)| and |Rth(400)−Rth(700)|, is required to be excellent in spectral transmittance. The spectral transmittance of the cellulose acylate film is preferably not less than 45% and not more than 95% at a wavelength of 380 nm and is not more than 10% at a wavelength of 350 nm.

In terms of volatilization, the molecular weight of the UV absorber is preferably from 250 to 1000, more preferably from 260 to 800, even more preferably from 270 to 800, or especially preferably from 300 to 800. Having a molecular weight that falls within the range, the compound may have a specific monomer structure or may have an oligomer structure or a polymer structure that comprises a plurality of such monomer units bonded.

The UV absorber is preferably not volatilized during the step of casting the dope or the step of drying the dope included in the process of preparing the cellulose acylate film.

Examples of the UV absorber of the cellulose acylate film include those described in JP-A-2006-199855, columns 0059-0135.

Preferably, fine particles are added as a mat agent to the cellulose acylate film. Fine particles for use in the invention includes silicon dioxide (silica), titanium dioxide, aluminum oxide, zirconium oxide, calcium carbonate, calcium carbonate, talc, clay, calcined kaolin, calcined calcium silicate, calcium silicate hydrate, aluminum silicate, magnesium silicate and calcium phosphate. Of the fine particles, preferred are those containing silicon as the haze of the film with them may be low, and more preferred is silicon dioxide. Preferably, fine particles of silicon dioxide for use herein have a primary mean particle size of not larger than 20 nm and an apparent specific gravity of at least 70 g/liter. Those having a mean particle size of the primary particles of from 5 to 16 nm are more preferred as capable of reducing the haze of the film with them. The apparent specific gravity is preferably from 90 to 200 g/liter or more, more preferably from 100 to 200 g/liter or more. Having a larger apparent specific gravity, the particles may form a dispersion of high concentration, and they are favorable as capable of reducing the haze of the film with them and capable bettering their aggregates.

The fine particles generally form secondary particles having a mean particle size of from 0.1 to 3.0 μm, and the fine particles may exist in the film as aggregates of their primary particles, therefore forming fine projections and recesses with a size of from 0.1 to 3.0 μm in the film surface. The secondary mean particle size is preferably from 0.2 μm to 1.5 more preferably from 0.4 μm to 1.2 μm, even more preferably from 0.6 μm to 1.1 μm. The primary or secondary particle size as referred to herein means the particle size as determined by observing the particles in the film with a scanning electronic microscope and measuring the diameter of the circle that circumscribes the particle. 200 different particles in different sites are analyzed and measured in that manner, and their mean value is the mean particle size.

For fine particles of silicon dioxide, for example, herein usable are commercial products of AEROSIL R972, R972V, R974, R812, 200, 200V, 300, R202, OX50, TT600 (all by Nippon Aerosil). Fine particles of zirconium oxide are commercially available, for example, as AEROSIL R976 and R811 (both by Nippon Aerosil), and they are usable herein.

Of those, especially preferred are AEROSIL 200V and AEROSIL R972V, as they are fine particles of silicon dioxide having a primary mean particle size at most 20 nm and an apparent specific gravity of at least 70 g/liter, and they are significantly effective for reducing the friction coefficient of the optical film with them while keeping the haze of the film low.

In the invention, in order to obtain a cellulose acylate film containing particles having a small secondary average particle diameter, dispersion liquid of particles may be used. various methods may be proposed to prepare a dispersion of particles. For example, a method may be employed which comprises previously preparing a particulate dispersion of particles in a solvent, stirring the particulate dispersion with a small amount of a cellulose acylate solution which has been separately prepared to make a solution, and then mixing the solution with a main cellulose acylate dope solution. This preparation method is desirable because the particulate silicon dioxide can be fairly dispersed and thus can be difficultly re-agglomerated. Besides this method, a method may be employed which comprises stirring a solution with a small amount of cellulose ester to make a solution, dispersing the solution with a particulate material using a dispersing machine to make a solution having particles incorporated therein, and then thoroughly mixing the solution having particles incorporated therein with a dope solution using an in-line mixer. These method are not specifically limited, in case where silicon dioxide fine particles are mixed with a solvent to form dispersion, the concentration of silicon dioxide is preferably from 5 to 30% by mass, more preferably from 10 to 25% by mass, even more preferably from 15 to 20% by mass. The dispersion having a higher concentration is preferred as capable of reducing the haze of the film with it and capable bettering its aggregates. Concretely, when the same amount of a dispersion having a higher concentration is added to a film, then the film may have a lower haze. An amount of the mat agent in the final cellulose acylate dope is preferably from 0.01 to 1.0 g per 1 m³, more preferably from 0.03 to 0.3 g per 1 m³, or even more preferably from 0.08 to 0.16 g per 1 m³.

The lower alcohol to be used is preferably methyl alcohol, ethyl alcohol, propyl alcohol, isopropyl alcohol or butyl alcohol. The solvent other than the lower alcohol is not limited, and the solvent which can be used in film-forming of the cellulose acylate can be also used.

Any additive(s) (e.g., plasticizers, UV inhibitors, anti-degradation agents, remover agents, infrared absorbers) other than the compound of lowering the optical anisotropy or the UV absorber may be added to the cellulose acylate film depending on the application thereof, and the additive may be selected from solid or oil materials. Namely, the additive is not limited in terms of the melting point or boiling point. For example, any mixture of UV absorbers having melting points of not higher than 20 degrees Celsius and not lower than 20 degrees Celsius respectively may be used, and any mixture of plasticizers described in JP-A-2001-151901 may be used. Examples of the infrared absorber are described in JP-A-2001-194522. The additive(s) may be added at any time during the step of preparing the dope, and is preferably added at the end of the step of preparing the dope. Furthermore, an amount of the additive is not limited as far as the additive can function as itself. in the embodiment wherein the cellulose acylate film has a multi-layered structure, the species or the amounts of the additive may be different among the layers. The techniques thereof have been known as described in JP-A-2001-151902. The details of the techniques are described in Hatsumei Kyokai Disclosure Bulletin No. 2001-1745 (published on Mar. 15, 2001 by Hatsumei Kyokai) pp. 16-22.

The plasticizer may be added or not be added to the cellulose acylate film as shown in Examples. Some compounds, which are capable of lowering the optical anisotropy, may also act as a plasticizer; and therefore, no plasticizer may be added to the film containing any of such compounds.

The cellulose acylate film is preferably prepared according to any solution film-forming method using a cellulose acylate solution. The dissolution method to be used in preparation of the cellulose acylate solution is not limited, the dissolution may be carried out at a room temperature, or the low-temperature-dissolution method, the high-temperature-dissolution method or the combination thereof may be carried out. Regarding the step of preparation of the cellulose acylate solution, the step of condensation of the solution along with the step of dissolution and the step of filtration, the details are described in Hatsumei Kyokai Disclosure Bulletin No. 2001-1745 (published on Mar. 15, 2001 by Hatsumei Kyokai) pp. 22-25, which are preferably used in the invention.

The dope-transparency of the cellulose acylate solution is preferably equal to or more than 85%. It is more preferably equal to or more than 88%, or even more preferably equal to or more than 90%. According to the present invention, the additive(s) is preferably dissolved in the cellulose acylate solution. The concrete method for calculating the dope-transparency is as follows. A 1 cm-square glass cell is filled with a cellulose acylate dope, and the absorbance at 550 nm is measured by using a spectrometer (for example, UV-3150, by Shimazu). Regarding the solvent only, the absorbance at 550 nm is measured as a blank, and the dope-transparency is calculated as a ratio of the absorbance of the cellulose acylate solution to the absorbance of the blank.

The cellulose acylate film may be produced by a conventional method of solution casting film formation, using a conventional apparatus for solution casting film formation. A dope (cellulose acylate solution) prepared in a dissolution machine (pot) is once stored in a storage pot, and after defoaming of bubbles contained in the dope, the dope is subjected to final preparation. Then, the dope is discharged from a dope exhaust and fed into a pressure die via, for example, a pressure constant-rate gear pump capable of feeding the dope at a constant flow rate at a high accuracy depending upon a rotational rate; the dope is uniformly cast from a nozzle (slit) of the pressure die onto a metallic support continuously running in an endless manner in the casting section; and at the peeling point where the metallic support has substantially rounded in one cycle, the half-dried dope film (also called a web) is peeled away from the metallic support. The obtained web is clipped at both ends and dried by conveying with a tenter while keeping a width. Subsequently, the obtained film is mechanically conveyed with a group of rolls in a dryer to terminate the drying and then wound in a roll form with a winder in a prescribed length. A combination of the tenter and the dryer of a group of rolls varies depending upon the purpose. In the solution casting film formation for the film formation of a functional protective film that is an optical member for liquid crystal display device which is a main application of the cellulose acylate film of the invention, in addition to a solution casting film forming apparatus, a coating apparatus is often added for the purpose of subjecting a coating layer such as a subbing layer, an antistatic layer, an anti-halation layer and a protective layer to coating and formation (coating processing) on the surface of the film. These are described in detail in Journal of Technical Disclosure, No. 2001-1745, pages 25 to 30, issued on Mar. 15, 2001 by Japan Institute of Invention and Innovation and are classified into casting (including co-casting), metallic support, drying, releasing (peeling) and so on. Those can be preferably adopted in the invention.

The thickness of the cellulose acylate film is preferably from 10 to 120 micro meters, more preferably from 20 to 100 micro meters, or even more preferably from 30 to 90 micro meters.

### Properties of Polymer Film to be Used as Transparent Support:

The preferable properties of the polymer film to be used as a transparent support in the present invention will be described in details below.

### <Re and Rth>

In this description, Re(λ) and Rth(λ) are retardation (nm) in plane and retardation (nm) along the thickness direction, respectively, at a wavelength of λ. Re(λ) is measured by applying light having a wavelength of λ nm to a film in the normal direction of the film, using KOBRA 21ADH or WR (by Oji Scientific Instruments). The selection of the measurement wavelength may be conducted according to the manual-exchange of the wavelength-selective-filter or according to the exchange of the measurement value by the program.

When a film to be analyzed is expressed by a monoaxial or biaxial index ellipsoid, Rth(λ) of the film is calculated as follows.

Rth(λ) is calculated by KOBRA 21ADH or WR on the basis of the six Re(λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in plane), a value of hypothetical mean refractive index, and a value entered as a thickness value of the film.

In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(λ) of the film is calculated by KOBRA 21ADH or WR.

Around the slow axis as the inclination angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to formulae (11) and (12):

$$Re ( θ ) = [ nx - \frac{ny \times nz}{\sqrt{\frac{{\{ ny sin ( {sin}^{- 1} ( \frac{sin ( - θ )}{nx} ) ) \}}^{2} +}{{\{ nz cos ( {sin}^{- 1} ( \frac{sin ( - θ )}{nx} ) ) \}}^{2}}}} ] \times \frac{d}{cos \{ {sin}^{- 1} ( \frac{sin ( - θ )}{nx} ) \}} \qquad ( 11 )$$

Re(θ) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the film.

Rth={(nx+ny)/2−nz}×d (12)

In the formula, nx represents a refractive index in the in-plane slow axis direction; ny represents a refractive index in the in-plane direction perpendicular to nx; and nz represents a refractive index in the direction perpendicular to nx and ny. And “d” is a thickness of the film.

When the film to be analyzed is not expressed by a monoaxial or biaxial index ellipsoid, or that is, when the film does not have an optical axis, then Rth(λ) of the film may be calculated as follows:

Re(λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation values, the estimated value of the mean refractive index and the inputted film thickness value, Rth(λ) of the film may be calculated by KOBRA 21ADH or WR.

In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some main optical films are listed below:

cellulose acylate (1.48), cycloolefin polymer (1.52), polycarbonate (1.59), polymethylmethacrylate (1.49) and polystyrene (1.59). KOBRA 21ADH or WR calculates nx, ny and nz, upon enter of the hypothetical values of these mean refractive indices and the film thickness. On the basis of thus-calculated nx, ny and nz, Nz=(nx-nz)/(nx-ny) is further calculated.

One example of the polymer film to be used as the transparent support is a low-retardation film having Re of from 0 to 10 nm and the absolute value of Rth of not more than 20 nm.

### <Coefficient of Humidity Expansion>

The coefficient of humidity expansion of the polymer film may be decided depending on the combination with the coefficient of thermal expansion, is preferably from 3.0×10⁻⁶ to 500×10⁻⁶% RH, is more preferably from 4.0×10⁻⁶ to 100×10⁻⁶% RH, is even more preferably from 5.0×10⁻⁶ to 50×10⁻⁶% RH, or most preferably from 5.0×10⁶ to 40×10⁻⁶% RH.

The coefficient of thermal expansion may be measured according to “18011359-2” as follows. A film sample is heated to 80 degrees Celsius from a room temperature, and then is cooled to a temperature of from 60 degrees Celsius to 50 degrees Celsius. The coefficient is calculated on the basis of the slope of the length of the film sample during the cooling.

For measuring the coefficient of humidity expansion, a film sample having a length (this is a measuring direction) of 25 cm and a width of 5 cm is cut from a long film along the long direction so that the direction giving the maximum elastic modulus is the long direction. The pin holes in a 20 cm interval are punched in the film sample, and the film sample is left in the atmosphere at 25 degrees Celsius and 10% RH for 24 hours, and then the interval between the holes is measured (measured value Lₒ) by a pin-gauge. Next, the film sample is left in the atmosphere at 25 degrees Celsius and 80% RH for 24 hours, and then the interval between the holes is measured (measured value L₁) by a pin-gauge. The coefficient of humidity expansion (% RH) of the film sample is calculated on the basis of these measured values according to the following formula.

Coefficient of Humidity Expansion={(L₁−L₀)/L₀}/(R₁−R₀)

### <Elastic Modulus>

The elastic modulus of the polymer film is not limited, is preferably from 1 to 50 GPa, more preferably from 5 to 50 GPa, or even more preferably from 7 to 20 GPa. The elastic modulus may be adjusted to the preferable range by selecting the species of the polymer, the species or amount of the additive or the stretching treatment.

The elastic modulus is measured as follows. A film sample having a length of 150 mm and a width of 10 mm is prepared, and is left in the atmosphere at 25 degrees Celsius and 60% RH for 24 hours, and then the measurement according to the standard “ISO527-3:1995” is conducted under the condition that the initial sample length is 100 mm and the tension rate is 10 mm/min. On the basis of the initial slope of the stress-strain curve, the tensile elastic modulus is calculated, which is the elastic modulus in the specification. Usually, the elastic modulus may be varied depending on which direction is determined as the long or width direction of the film, and, in the specification, the elastic modulus is defined as the value which is measured for the sample prepared along the direction giving the maximum value. If the elastic modulus along the direction giving the maximum sound wave velocity is defined as E1 and the elastic modulus along the direction orthogonal to the direction is defined as E2, the ratio thereof (E1/E2) is preferably from 1.1 to 5.0, or more preferably from 1.5 to 3.0 in terms of keeping the flexibility of the film and reducing the dimension variation of the film.

According to the invention, the direction giving the maximum sound wave velocity is obtained as follows. The film to be analyzed is conditioned at 25 degrees Celsius and at a relative humidity of 60% for 24 hours, then by using an orientation analyzer (SST-2500, by Nomura Shoji), the direction giving the maximum sound wave velocity is obtained as the direction giving the maximum velocity of transmitting the longitudinal wave of the ultrasonic pulse.

### <Total Transmittance or Haze>

According to the present invention, a sample is conditioned at 25 degrees Celsius and at a relative humidity of 60% for 24 hours, and then, by using a haze meter (NDH 2000, by Nippon Denshoku), the values are measured as haze and the total transmittance.

The polymer film having the higher total transmittance is more preferable in terms of the efficiency of the light emitted from the light source and reducing the electricity consumption of the panel. And the total transmittance is preferably equal to or more than 85%, more preferably equal to or more than 90% or even more preferably equal to or more than 92%. Haze of the film is preferably equal to or less than 5%, more preferably equal to or less than 3%, even more preferably equal to or less than 3%, or especially preferably equal to or less than 0.5%.

### <Tear Strength>

According to the invention, the tear strength test (Ermendorf Tear Method) is conducted as follows. Film samples having a dimension of 64 mm×50 mm are cut from a long film along the directions parallel and orthogonal to the slow direction of the film respectively, and are left in the atmosphere at 25 degrees Celsius and 60% RH for 2 hours, and then, by using a light-load tear strength tester, the measurement is conducted. The smaller value is defined as the Lear strength.

The tear strength of the polymer film is preferably from 3 to 50 g, more preferably from 5 to 40 g, or even more preferably from 10 to 30 g in terms of the fragility of the film.

### <Thickness>

The thickness of the polymer film is preferably from 10 to 1000 micro meters, more preferably from 40 to 500 micro meters, or even more preferably from 40 to 200 micro meters in terms of reducing the producing cost.

### 2. Polarizing Plate

The present invention relates to also the polarizing plate having the optical film of the invention. One embodiment of the polarizing plate of the invention comprises the optical film of the invention and a polarizing film, wherein the in-plane slow axes of the first and second retardation regions are along the direction of 45° respectively relative to the absorption axis of the polarizing film. The polarizing plate of the invention may be disposed at the viewed side of the displaying device for displaying 3D images so that the optical film faces to the viewed side.

Embodiments of the polarizing plate of the invention include not only the film-shaped embodiments which can be incorporated directly but also long band-shaped and roll-shaped embodiments (for example, the roll length is equal to or longer than 2500m or 3900m) which are obtained in the continuous production. The width of the polarizing plate is preferably equal to or more than 1470 mm when the polarizing plate is used in a large-screen displaying device.

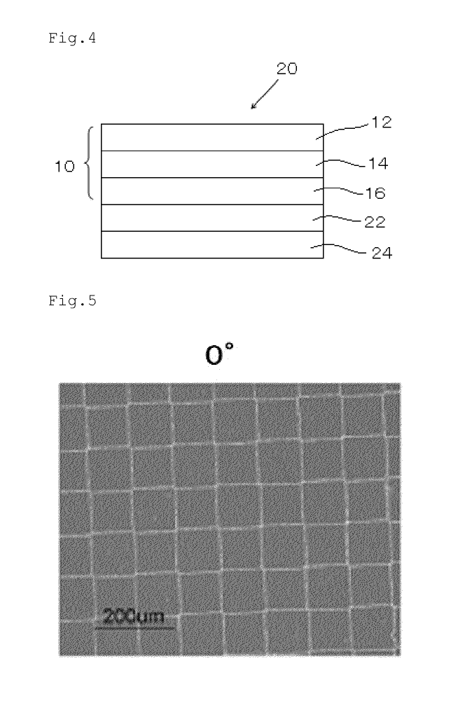

The layer construction of the polarizing plate is not limited. The polarizing plate may have a usual layer-construction. One feature of the polarizing plate resides in that it has the optical film of the invention. FIG. 4 is a cross-section view showing a frame format of an example of the polarizing plate of the present invention. The polarizing plate 20 shown in FIG. 4 has a polarizing film 22, the optical film of the present invention on one surface thereof, and a protective film 24 on another surface thereof. Examples of the polymer film to be used as the protective film 24 are same as those of the polymer film to be used as the transparent support of the optical film 10.

### Method for Manufacturing Polarizing Plate

An exemplary method for manufacturing the polarizing plate of the present invention includes:

transporting a long polymer film being a transparent support, such as a cellulose acylate film, and sequentially forming an alignment film thereon during the transportation;

sequentially rubbing the alignment film in the direction at approximately 45° from the film transport direction;

applying a composition comprising a liquid crystal compound having a polymerizable group onto the rubbed surface of the alignment film;

heating the laminate at a temperature T₁° C. to align liquid crystal molecules into an orthogonal alignment state in which their slow axes are orthogonal to the rubbed direction;

disposing a striped photomask such that the boundary between a shielding site and a transmissive site is parallel to the film transport direction and then irradiating the laminate with ultraviolet rays through the photomask for fixation of the orthogonal alignment state to form the first retardation region;

heating the laminate at a temperature T₂° C. (where T₁<T₂) to align the liquid crystal molecules into a parallel alignment state in which their slow axes are parallel to the rubbed direction;

exposing the entire laminate to light for fixation of the parallel alignment state to form the second retardation region; and

laminating the resulting laminate and a long polarizing film having a transmission axis in the width direction by a roll-to-roll process.

The polarizing plate of the present invention can be produced to a continuous production process at low cost as compared to traditional manufacturing processes. Since the rubbed direction is approximately 45° from the film transport direction, the rolled polarizing plate does not require oblique punching. This can reduce production costs of the polarizing plate.

### Polarizing Film:

The polarizing film may be selected from the commonly-used polarizing films. For example, the polarizing films formed of polyvinyl alcohol films dyed with iodine or dichroic dyes may be used.

### Adhesion Layer:

The polarizing plate of the present invention may have an adhesion layer disposed between the optical film and the polarizing film. The adhesion layer to be used for sticking the optical film and the polarizing film may be formed of a material having the ration of G″ to G′ (tan δ−G″/G′) of from 0.001 to 1.5, where G″ and G′ are measured by a dynamic viscoelasticity measurement device. Examples of such a material include the adhesion agents and the easily-creeping materials. Examples of the adhesion material include polyvinyl-alcohol series adhesion agents.

### Antireflection Layer:

Any functional layer such as an antireflection layer is preferably formed on the surface of the polarizing plate which is disposed at the side opposite to the liquid crystal cell. Especially, according to the invention, an antireflection layer having a lamination of a light-scattering layer and a low-refractive layer formed in this order on a transparent protective film or an antireflection layer having a lamination of middle-refractive layer, high-refractive layer and low-refractive layer formed in this order on a transparent protective film is preferable. The antireflection layer may efficiently prevent the flicker from occurring due to the reflection of the outside light especially when 3D images are displayed. A preferred example of these will now be described in detail.

A preferred example of a antireflection layer including a transparent protective film, a light-scattering layer, and a low-refractive layer will now be described, the light-scattering layer and the low-refractive-index layer overlying the transparent protective film.

Matting particles are dispersed in the light-scattering layer, and the material of the light-scattering layer other than the matting particles preferably has a refractive index of 1.50 to 2.00. The low-refractive-index layer preferably has a refractive index of 1.35 to 1.49. The light-scattering layer has antiglare and hardcoat functions and may have a monolayer structure or a multilayered structure, for example, including two to four layers.

The antireflection layer has an uneven surface having a center-line average roughness Ra (0.08 to 0.40 μm), a ten-point average roughness Rz (not more than 10 times Ra), an average peak-valley distance Sm (1 to 100 μm), a standard deviation of the peak height measured from the deepest point (not more than 0.5 μm), a standard deviation of the average peak-valley distance Sm based on the center line (not more than 20 μm), and a proportion of a plane at a tilt angle of 0 to 5° (not less than 10%), which can develop a sufficient antiglare function and provide a uniform matting texture through visual observation; hence, such an antireflection layer is preferred.

The hue of reflected light with a C illuminant is preferably neutral in the case where the reflected light has hue values a* of −2 to 2 and b* of −3 to 3 and a ratio of the minimum refractive index to the maximum refractive index of 0.5 to 0.99 at a wavelength of 380 to 780 nm. It is also preferred that the b* value of transmitted light from a C illuminant ranges from 0 to 3, which can reduce yellow coloration in the white-displaying mode of a display device including the antireflection layer.

Preferably, a lattice of 120 μm by 40 μm is inserted between a surface illuminant and the antireflection film to reduce the standard deviation in the observed brightness distribution to 20 or less because glare in a high-definition panel including the film of the present invention can be decreased.

The antireflection layer preferably has optical characteristics including a mirror reflectance of not more than 2.5%, a light transmittance of not less than 90%, and a 60° glossiness of not more than 70%, which can reduce the reflection of external light and enhance the visibility. In particular, the mirror reflectance is more preferably not more than 1%, most preferably not more than 0.5%. In order to prevent glare on a high-definition liquid crystal display (LCD) panel and reduce the blur of letters, it is preferred that a haze value range from 20 to 50%, the ratio of an inner haze value to the total haze value ranges from 0.3 to 1, a decrease between the haze value after the formation of the light scattering layer and the haze value after the formation of the low-refractive layer be not more than 15%, the visibility of transmission images at a comb width of 0.5 mm range from 20 to 50%, and the transmission ratio of orthogonally transmitted light to direction inclined by 2° from the orthogonal direction range from 1.5 to 5.0.

The low-refractive layer has a refractive index of 1.20 to 1.49, more preferably 1.30 to 1.44. The low-refractive layer preferably satisfies Formula (IX) in terms of a reduction in reflectance:

(mλ/4)×0.7<n1d1<(mλ/4)×1.3 Formula (IX)

In Formula (IX), m represents a positive odd number, n1 represents a refractive index of the low-refractive layer, and d1 represents a thickness (nm) of the low-refractive layer. In addition, λ represents a wavelength ranging from 500 to 550 nm.

The low-refractive layer contains a fluorinated polymer as a low-refractive-index binder. A preferred fluorinated polymer has a coefficient of dynamic friction of 0.03 to 0.20, a contact angle to water of 90° to 120°, and a pure water-sliding angle of not more than 70° and is crosslinked by heat or exposure to ionizing radiation. In the case where the antireflection film of the present invention is incorporated into image display devices, the low-refractive layer preferably has small peel force from commercially available adhesive tapes because seals or memo pads stuck to the antireflection film can be easily removed. The peel force is preferably not more than 500 gf, more preferably not more than 300 gf, and most preferably not more than 100 gf. The higher the surface hardness measured with a micro hardness tester, the more resistant to damage. The surface hardness is preferably not less than 0.3 GPa, more preferably not less than 0.5 GPa.

Examples of the fluorinated polymer incorporated into the low-refractive layer include products obtained by hydrolysis or dehydration condensation of perfluoroalkyl group-containing silane compounds [e.g., (heptadecafluoro-1,1,2,2-tetrahydrodecyl)triethoxysilane] and fluorinated copolymers consisting of a fluorinated monomer unit and a crosslinkable unit.

Specific examples of the fluorinated monomer include fluoroolefins (e.g., fluoroethylene, vinylidene fluoride, tetrafluoroethylene, perfluorooctylethylene, hexafluoropropylene, and perfluoro-2,2-dimethyl-1,3-dioxole), partly or completely fluorinated alkyl ester derivatives of (meth)acrylic acid [e.g., VISCOAT 6FM (manufactured by OSAKA ORGANIC CHEMICAL INDUSTRY LTD.) and M-2020 (manufactured by Daikin Industries, Ltd.)], and completely or partially fluorinated vinyl ethers. Among these, preferred are perfluoroolefins; and particularly preferred is hexafluoropropylene in view of refractive index, solubility, transparency, and availability.

Examples of the crosslinkable unit include constituent units obtained by polymerization of monomers originally having a self-crosslinkable group in their molecules, such as glycidyl(meth)acrylate and glycidyl vinyl ether; constituent units obtainable by polymerization of monomers having a carboxyl group, a hydroxyl group, an amino group, and a sulfo group [e.g., (meth)acrylic acid, methylol (meth)acrylate, hydroxyalkyl(meth)acrylate, allyl acrylate, hydroxyethyl vinyl ether, hydroxybutyl vinyl ether, maleic acid, and crotonic acid]; and constituent units obtained by introduction of crosslinking reactive groups, such as a (meth)acryloyl group, into these constituent units by a polymerization reaction (e.g., a crosslinking reactive group can be introduced by a procedure for allowing acrylic acid chloride to act on a hydroxyl group).

Besides the fluorinated monomer unit and constituent unit for imparting crosslinking reactivity, a fluorine-free monomer can be copolymerized in view of solubility in solvents and transparency of films. Examples of the monomer unit usable in combination include, but are not limited to, olefins (e.g., ethylene, propylene, isoprene, vinyl chloride, and vinylidene chloride), acrylic acid esters (e.g., methyl acrylate, ethyl acrylate, and 2-ethylhexyl acrylate), methacrylic acid esters (e.g., methyl methacrylate, ethyl methacrylate, butyl methacrylate, and ethylene glycol dimethacrylate), styrene derivatives (e.g., styrene, divinylbenzene, vinyltoluene, and α-methylstyrene), vinyl ethers (e.g., methyl vinyl ether, ethyl vinyl ether, and cyclohexyl vinyl ether), vinyl esters (e.g., vinyl acetate, vinyl propionate, and vinyl cinnamate), acrylamides (e.g., N-tert-butyl acrylamide and N-cyclohexyl acrylamide), methacrylamides, and acrylonitrile derivatives.

These polymers may be appropriately used in combination with curing agents as is disclosed in JP-A-10-25388 and JP-A-10-147739.

The light-scattering layer is formed to impart some functions to the film, such as a light diffusion function due to surface scattering and/or internal scattering and a hardcoat function for enhancing the abrasion resistance of the film. The light-scattering layer is therefore composed of a binder for imparting a hardcoat function, matting particles for imparting a light diffusion function, and if needed, an inorganic filler which contributes to an increase in a refractive index, prevention of crosslinking shrinkage, and an enhancement in strength.

The light-scattering layer has a thickness preferably ranging from 1 to 10 μm, and more preferably 1.2 to 6 μm to impart the hardcoat function and suppress the occurrence of curl and increased brittleness.

A preferred binder used for the light-scattering layer is a polymer having a saturated hydrocarbon chain or polyether chain as the principal chain, more preferred is a polymer having a saturated hydrocarbon chain as the principal chain. Furthermore, the binder polymer preferably has a crosslinking structure. Preferred binder polymers having saturated hydrocarbon chains as the principal chains are polymers of ethylenically unsaturated monomers. Preferred binder polymers having saturated hydrocarbon chains as the principal chains and having crosslinking structures are (co)polymers of monomers having two or more ethylenically unsaturated groups. Binder polymers exhibiting a high refractive index can be employed, which has an aromatic ring or contains at least one atom selected from a halogen atom other than fluorine, a sulfur atom, a phosphorus atom, and a nitrogen atom in the monomer structure described above .

Examples of the monomers having two or more ethylenically unsaturated groups include esters of a polyhydric alcohol and (meth)acrylic acid [e.g., ethylene glycol di(meth)acrylate, butanediol di(meth)acrylate, hexanediol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylates, and polyester polyacrylates]; ethylene oxide modified products thereof; vinylbenzene and derivatives thereof (e.g., 1,4-divinylbenzene, 2-acryloylethyl 4-vinylbenzoate, and 1,4-divinylcyclohexanone); vinylsulfones (e.g., divinylsulfone); acrylamides (e.g., methylenebisacrylamide); and methacrylamides. These monomers may be used in combination.

Specific examples of the high-refractive-index monomers include bis(4-methacryloylthiophenyl)sulfide, vinylnaphthalene, vinylphenyl sulfide, and 4-methacryloxyphenyl-4′-methoxyphenyl thioether. These monomers may also be used in combination.

Such ethylenically unsaturated group-containing monomers can be polymerized by exposure to ionizing radiation or heating in the presence of a photo radical initiator or a heat radical initiator.

In particular, the antireflection film can be formed by preparing a coating solution containing the ethylenically unsaturated group-containing monomer, a photo radical initiator or heat radical initiator, matting particles, and an inorganic filler; applying the coating solution onto a transparent support; and then curing this product through a polymerization reaction by exposure to ionizing radiation or heating. Typical photo radical initiators can be used in the formation of the antireflection film.

Preferred polymers having the principal chains being polyether are ring-opening polymers of polyfunctional epoxy compounds. The ring-opening polymerization of the polyfunctional epoxy compounds can be carried out by exposure to ionizing radiation or heating in the presence of a photoacid generator or a thermal acid generator.

In particular, the antireflection film can be formed by preparing a coating solution composed of the polyfunctional epoxy compound, a photoacid generator or thermal acid generator, matting particles, and an inorganic filler; applying the coating solution onto a transparent support; and then curing this product through a polymerization reaction by exposure to ionizing radiation or heating.

In place of, or in addition to, the monomer having two or more ethylenically unsaturated groups, a crosslinking structure may be introduced into the binder polymer by introducing crosslinkable groups into the polymer with the aid of a crosslinkable group-containing monomer and then allowing the crosslinkable groups to react.

Examples of the crosslinkable group include an isocyanate group, an epoxy group, an aziridine group, an oxazoline group, an aldehyde group, a carbonyl group, a hydrazine group, a carboxyl group, a methylol group, and an active methylene group. Vinylsulfonic acid, acid anhydrides, cyano acrylate derivatives, melamine, etherified methylol, esters, urethanes, and metal alkoxides (e.g., tetramethoxysilane) can also be utilized as the monomer used for the introduction of a crosslinking structure. A functional group which has crosslinking properties as a result of a decomposition reaction, such as block isocyanate group, may also be used. In other words, in the present invention, the crosslinkable group may exhibit reactivity after a decomposition reaction, instead of direct reactivity.

The binder polymer having such a crosslinkable group can be applied and then heated to form a crosslinking structure.

In order to develop the antiglare function, the light-scattering layer contains matting particles which are larger than filler particles and have an average particle size of 1 to 10 μm, preferably 1.5 to 7.0 μm, such as particles of an inorganic compound or resin particles.

Specific examples of preferred matting particles include particles of an inorganic compound (e.g., silica particles and TiO₂ particles) and resin particles (e.g., acrylic particles, crosslinked acrylic particles, polystyrene particles, crosslinked styrene particles, melamine resin particles, and benzoguanamine resin particles). Among these, particularly preferred are crosslinked styrene particles, crosslinked acrylic particles, crosslinked acrylic-styrene particles, and silica particles. The matting particles may have either a spherical shape or an amorphous shape.

Two or more types of matting particles having different particle diameters may be used in combination. Matting particles having a larger particle size can develop the antiglare function while matting particles having a smaller particle size can develop different optical characteristics.

Most preferably, the matting particles exhibit a monodispersed particle size distribution, and individual particles have an identical particle size as much as possible. For example, assuming that particles having a particle diameter 20% larger than the average particle diameter are defined as coarse particles, the coarse particles preferably account for not more than 1%, more preferably not more than 0.1%, and further preferably not more than 0.01% relative to the entire particles. Matting particles exhibiting such particle size distribution can be obtained by classification after a normal synthetic reaction, and an increase in the number of classification steps or an enhancement in a requirement for the classification can contribute to production of a matting agent having a more preferred particle size distribution.

The matting particles are incorporated into the light-scattering layer such that the matting particle content in the formed light-scattering layer preferably ranges from 10 to 1000 mg/m², more preferably 100 to 700 mg/m².

The particle size distribution of the matting particles is measured with a Coulter counter, and the measured distribution is converted into a particle number distribution.

In order to enhance the refractive index of the light-scattering layer, the light-scattering layer preferably contains, in addition to the matting particles, an inorganic filler composed of an oxide of at least one metal selected from titanium, zirconium, aluminum, indium, zinc, tin, and antimony, the inorganic filler having an average particle size of not more than 0.2 μm, preferably not more than 0.1 μm, and more preferably not more than 0.06 μm.

In contrast, in order to achieve a large difference in refractive index from the matting particles, silicon oxides are preferably used in the light-scattering layer containing high-refractive-index matting particles, which can keep a low refractive index of the light-scattering layer. A preferred particle size is the same as that of the above-mentioned inorganic filler.

Specific examples of the inorganic filler usable in the light-scattering layer include TiO₂, ZrO₂, Al₂O₃, In₂O₃, ZnO, SnO₂, Sb₂O₃, ITO, and SiO₂. Among these, particularly preferred are TiO₂ and ZrO₂ in view of an increase in a refractive index. The surface of the inorganic filler is preferably treated with a silane coupling agent or a titanium coupling agent. A preferred surface-treating agent has a functional group which can react with the binders on the surface of the filler.

The amount of such an inorganic filler to be added preferably ranges from 10 to 90%, more preferably 20 to 80%, and further preferably 30 to 75% relative to the total mass of the light-scattering layer.

Since such a filler has a particle diameter sufficiently smaller than the wavelength of light, it does not cause scattering, and a dispersion containing the filler dispersed in a binder polymer behaves as an optically uniform substance.

The mixture of the binder and the inorganic filler contained in the light-scattering layer preferably has a bulk refractive index ranging from 1.48 to 2.00, more preferably 1.50 to 1.80. Proper selection of the types and relative amounts of the binder and the inorganic filler enables the refractive index to fall within these ranges. Proper selection thereof can be readily determined through experiments

In particular, in order to ensure the surface uniformity of the light-scattering layer regardless of, for instance, uneven coating, uneven drying, and point defects, a fluorine surfactant and/or a silicone surfactant is preferably contained in a coating composition for the formation of an antiglare layer. Specifically, use of a smaller amount of fluorine surfactant can preferably overcome the surface defects of the antireflection film of the present invention, such as uneven coating, uneven drying, and point defects. Such a surfactant is added to enhance the surface uniformity and enables high-speed coating achieving high productivity.

An antireflection film including a transparent protective film, a middle-refractive layer, a high-refractive layer, and a low-refractive layer will now be described, each layer being formed over the transparent protective film in sequence.

The antireflection film having a layered structure at least including the middle-refractive layer, the high-refractive layer, and the low-refractive layer (outermost layer) formed over the transparent protective film in sequence is designed so as to have refractive indexes satisfying the following relationship:

Refractive index of high-refractive layer>refractive index of middle-refractive layer>refractive index of transparent support>refractive index of low-refractive layer

A hardcoat layer may be provided between the transparent protective film and the middle-refractive layer. Furthermore, the antireflection layer may consist of a middle-refractive hardcoat layer, a high-refractive layer, and a low-refractive layer (see, JP-A-8-122504, JP-A-8-110401, JP-A-10-300902, JP-A-2002-243906, and JP-A-2000-111706). Furthermore, any other function may be imparted to each of the layers; for example, an antifouling function may be imparted to a low-refractive layer, and an antistatic function may be imparted to a high-refractive layer (see, JP-A-10-206603, JP-A-2002-243906).

The antireflection film preferably has a strength of not less than H, more preferably not less than 2H, and most preferably not less than 3H defined by a pencil hardness test in accordance with JIS K5400.

### High-Refractive Layer and Middle-Refractive Layer

The high-refractive layer of the antireflection film includes a curable film at least containing ultrafine particles of a high-refractive-index inorganic compound and a matrix binder, the ultrafine particles having an average particle size of not more than 100 nm.

Examples of the material for the ultrafine particles of a high-refractive-index inorganic compound include inorganic compounds having a refractive index of not less than 1.65, preferably not less than 1.9. Examples of such inorganic compounds include oxides of Ti, Zn, Sb, Sn, Zr, Ce, Ta, La, and In; and composite oxides containing such metal atoms.

For example, techniques for producing such ultrafine particles involve a surface treatment of particles with a surface preparation agent (e.g., a treatment with a silane coupling agent disclosed in JP-A-11-295503, JP-A-11-153703, and JP-A-2000-9908 and a treatment with an anionic compound or an organometallic coupling agent disclosed in JP-A-2001-310432), employment of a core-shell structure with cores of high-refractive-index particles (see, JP-A-2001-166104 and JP-A-2001-310432), and combined use of specific dispersants (see, JP-A-11-153703, U.S. Pat. No. 6,210,858, and JP-A-2002-2776069).

Examples of a material used in the matrix include typical thermoplastic resins and curable resin films.

Furthermore, preferred is at least one composition selected from compositions composed of polyfunctional compounds having at least two radical polymerizable and/or cationic polymerizable groups and compositions composed of organometallic compounds having a hydrolyzable group and partial condensates thereof. Examples of such compositions are disclosed in JP-A-2000-47004, JP-A-2001-315242, JP-A-2001-31871, and JP-A-2001-296401. Curable films which can be formed from metal alkoxide compositions and colloidal metal oxides prepared from hydrolytic condensates of metal alkoxides are also preferably employed. Such curable films are, for example, disclosed in JP-A-2001-293818.

In general, high-refractive layers have a refractive index of 1.70 to 2.20. The high-refractive layer preferably has a thickness ranging from 5 nm to 10 μm, more preferably 10 nm to 1 μm.

The middle-refractive layer is adjusted so as to have a refractive index between the refractive index of the low-refractive layer and the refractive index of the high-refractive layer. The middle-refractive layer preferably has a refractive index of 1.50 to 1.70. The middle-refractive layer preferably has a thickness of 5 nm to 10 μm, and more preferably from 10 nm to 1 μm.

The low-refractive layer is sequentially laminated on the high-refractive layer. The low-refractive layer has a refractive index of 1.20 to 1.55, preferably 1.30 to 1.50.

The low-refractive layer is preferably configured as the outermost layer having abrasion resistance and antifouling characteristics. In order to significantly enhance the abrasion resistance, slippage is effectively imparted to the surface of the low-refractive layer, and traditional techniques for thin layers, such as introduction of silicone and introduction of fluorine, can be employed.

The fluorinated compound preferably has a refractive index of 1.35 to 1.50, more preferably 1.36 to 1.47. Preferred fluorinated compounds have crosslinkable or polymerizable functional groups containing 35 to 80% by mass fluorine atoms.

Examples of such compounds include compounds disclosed in paragraphs [0018] to [0026] in JP-A-9-222503, paragraphs [0019] to [0030] in JP-A-11-38202, paragraphs [0027] to [0028] in JP-A-2001-40284, and JP-A-2000-284102.

Preferred are silicone compounds each having a polysiloxane structure, a curable or polymerizable functional group in the polymer chain, and a crosslinked structure in a film. Examples of such preferred silicone compounds include reactive silicones [e.g., Silaplane (manufactured by JNC CORPORATION)] and polysiloxanes having silanol groups at their two terminals (see, JP-A-11-258403).

Preferably, a coating composition for the formation of the outermost layer is applied and exposed to light or heat during or after the application of the coating composition to facilitate a crosslinking or polymerization reaction of a fluorinated and/or siloxane polymer having a crosslinkable or polymerizable group, the coating composition containing a polymerization initiator, a sensitizer, and other components.

In addition, a sol-gel cured film is preferably employed, which can be produced by curing through a condensation reaction of an organometallic compound (e.g., a silane coupling agent) with a specific silane coupling agent having a fluorinated hydrocarbon group in the presence of a catalyst.

Examples of the material of such a sol-gel cured film include polyfluoroalkyl group-containing silane compounds or partial hydrolytic condensates thereof (e.g., compounds disclosed in JP-A-58-142958, JP-A-58-147483, JP-A-58-147484, JP-A-9-157582, and JP-A-11-106704); and silyl compounds containing a poly(perfluoroalkyl ether) group being a fluorinated long-chain group (e.g., compounds described in JP-A-2000-117902, JP-A-2001-48590, and JP-A-2002-53804).

In addition to the additives described above, the low-refractive layer can contain a filler, a silane coupling agent, a lubricant, a surfactant, or other components, the filler being, for example, low-refractive-index inorganic compounds having an average primary particle size of 1 to 150 nm [e.g., silicon dioxide (silica) and fluorinated particles (such as magnesium fluoride, calcium fluoride, and barium fluoride)] and organic fine particles disclosed in paragraphs [0020] to [0038] in JP-A-11-3820.

In the case where the low-refractive layer is positioned under the outermost layer, the low-refractive layer may be formed by a gas phase process [for instance, vacuum vapor deposition, sputtering, ion plating, and plasma chemical vapor deposition (CVD)]. Preferred is a coating method, which enables the low-refractive layer to be produced at low cost.

The low-refractive layer preferably has a thickness of 3D to 200 nm, more preferably 50 to 150 nm, and most preferably 60 to 120 nm.

Furthermore, a hardcoat layer, a forward scattering layer, a primer layer, an antistatic layer, an undercoat layer, a protective layer, and other layers may be provided.

### 3. Image Display Device and Stereoscopic Image Display System

The present invention relates to the image display device and the stereoscopic image display device employing the optical film of the present invention. One example of the image display device comprises:

a first polarizing film and a second polarizing film,

a liquid crystal cell disposed between the first and second polarizing films, comprising a pair of substrates and a liquid crystal layer disposed between the pair of substrates, and

an optical film disposed on the outer side of the first polarizing film;

wherein the angle between each of slow axes in plane of first retardation regions or second retardation regions of the optical film and an absorption axis of the first polarizing film is ±45°.

One example of the stereoscopic image display device comprises:

the image display device, and

a third polarizing plate disposed at the outside of the optical film

wherein the stereoscopic images are viewed through the third polarizing plate.

The image display device of the invention may employ any modes such as a TN (Twisted Nematic), IPS (In-Plane Switching), FLC (Ferroelectric Liquid Crystal), AFLC (Anti-ferroelectric Liquid Crystal), OCB (Optically Compensatory Bend), STN (Supper Twisted Nematic), VA (Vertically Aligned) and HAN(Hybrid Aligned Nematic) modes.

### Third Polarizing Plate:

According to the stereoscopic image display system of the present invention, the stereoscopic images (3D images) are viewed through a glasses-shaped polarizing plate (third polarizing plate).

### <Polarization Glasses>

One preferable embodiment of the present invention is the display system comprising polarization glasses of which the slow axes in the glasses for the right and left eyes are orthogonal to each other, wherein the polarization images for the right eye coming out from one of the first or second retardation regions are transmissive through the glass for the right eye and blocked by the glass for the left eye, and the polarization images for the left eye coming out from another of the first or second retardation regions are transmissive through the glass for the left eye and blocked by the glass for the right eye.

The polarization glasses may comprise a retardation layer and a linear polarizer. Other member having a same function as the polarizer may be used in place of the polarizer.

The concrete configurations of the 3D image display system of the invention, including polarized glasses, are described below. First, the optical film is so designed as to have the above-mentioned first retardation regions and the above-mentioned second retardation regions that differ in the polarized light conversion function on multiple first lines and multiple second lines alternately repeated in the image display panel (for example, when the lines run in the horizontal direction, the domains may be on the odd-numbered lines and even-numbered lines in the horizontal direction, and when the lines run in the vertical direction, the domains may be on the odd-numbered lines and the even-numbered lines in the vertical direction). In case where a circularly-polarized light is used for display, the retardation of the above-mentioned first retardation regions and that of the second retardation regions are preferably both λ/4, and more preferably, the slow axes of the first retardation regions and the second retardation regions are perpendicular to each other.

In case where a circularly-polarized light is used for display, preferably, the retardation of the above-mentioned first retardation regions and that of the second retardation regions are both λ/4, the right-eye image is displayed on the odd-numbered lines of the image display panel, and when the slow axis in the odd-lined retardation region is in the direction of 45 degrees, a λ/4 plate is arranged in both the right-eye glass and the left-eye glass of the polarized glasses, and the λ/4 plate of the right-eye glass of the polarized glasses may be fixed concretely at about 45 degrees. In the above-mentioned situation, similarly, the left-eye image is displayed on the even-numbered lines of the image display panel, and when the slow axis of the even-numbered line retardation region is in the direction of 135 degrees, then the slow axis of the left-eye glass of the polarized glasses may be fixed concretely at about 135 degrees.

Further, from the viewpoint that a circularly-polarized image light is once outputted via the patterned retardation film and its polarization state is returned to the original state through the polarized eyeglasses, the angle of the slow axis to be fixed of the right-eye glass in the above-mentioned case is preferably nearer to accurately 45 degrees in the horizontal direction. Also preferably, the angle of the slow axis to be fixed of the left-eye glass is nearer to accurately 135 degrees (or -45 degrees) in the horizontal direction.

For example, in a case where the image display panel is a liquid-crystal display panel, in general, it is desirable that the absorption axis direction of the panel front-side polarizer is in the horizontal direction and the absorption axis of the linear polarizing element of the polarized glasses is in the direction perpendicular to the absorption axis direction of the front-side polarizer, and more preferably, the absorption axis of the linear polarizing element of the polarized glasses is in the vertical direction.

Also preferably, the absorption axis direction of the liquid-crystal display panel front-side polarizer is at an angle of 45 degrees to each slow axis of the odd-numbered line retardation region and the even-numbered line retardation region of the patterned retardation film from the viewpoint of the polarized light conversion efficiency of the system.

Preferred configurations of the polarized glasses as well as those of the patterned retardation film and the liquid-crystal display device are disclosed in, for example, JP-A 2004-170693.

As examples of polarized glasses usable here, there are mentioned those described in JP-A 2004-170693, and as commercial products thereof, there are mentioned accessories to Zalman's ZM-M220W.

### EXAMPLES

The invention is described in more detail with reference to the following Examples. In the following Examples, the material used, its amount and ratio, the details of the treatment and the treatment process may be suitably modified or changed not overstepping the sprit and the scope of the invention. Accordingly, the invention should not be limitatively interpreted by the Examples mentioned below.

### Example 1

Production of Transparent Support Provided with Rubbed Alignment Film

An aqueous 4% polyvinyl alcohol (KURARAY POVAL PVA-103 manufactured by KURARAY CO., LTD.) solution was applied onto a surface of a transparent glass support with a #12 bar, and the coating was dried at 80° C. for 5 min. The coating was then unidirectionally rubbed forward and backward 3 times at 400 rpm to produce a glass support provided with a rubbed alignment film. The glass support exhibited an Re(550) of 0 nm and an Rth of 0 nm, and the alignment film had a thickness of 0.9 μm.

### Production of Patterned Optically Anisotropic Layer

A composition for an optically anisotropic layer was prepared as shown below and then filtered through a polypropylene filter having a pore size of 0.2 μm to produce a coating solution for an optically anisotropic layer. The coating solution was applied, and then the coating was dried at a surface temperature of 80° C. for 1 min into a liquid crystal phase for uniform molecular alignment and then cooled to room temperature. A lattice mask having 100 μm squares was then disposed on the substrate to which the coating solution for an optically anisotropic layer had been applied, and the product was irradiated with ultraviolet rays for 5 seconds with an air-cooled metal halide lamp of 20 mW/cm² (manufactured by EYE GRAPHICS CO., LTD.) in air to fix the alignment state, thereby forming a first retardation region. The surface temperature was then increased to 140° C. to temporarily convert the alignment state into an isotropic phase and then decreased to 100° C., and the temperature was kept to heat the product for 1 min for uniform molecular alignment. The temperature was then decreased to room temperature, and then the entire coating was exposed to light at an illuminance of 20 mW/cm² for 20 seconds to fix the alignment state, thereby forming a second retardation region. The first and second retardation regions have orthogonal slow axes, and the film had a thickness of 0.8 μm.

Composition for Optically Anisotropic Layer

| | | |
|---|---|---|
| Discotic liquid crystal E-1 | 100 | parts by mass |
| Alignment film interface aligning agent (II-1) | 1.0 | parts by mass |
| Air interface aligning agent (P-1) | 0.4 | parts by mass |
| Photopolymerization initiator | 3.0 | parts by mass |
| (IRGACURE 907 manufactured by BASF Japan Ltd.) | | |
| Sensitizer | 1.0 | parts by mass |
| (KAYACURE DETX manufactured by Nippon Kayaku Co., Ltd.) | | |
| Methyl ethyl ketone | 300 | parts by mass |

Discotic liquid crystal E-1 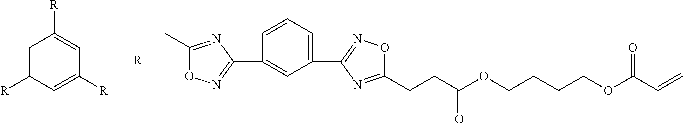
Alignment film interface aligning agent (II-1) 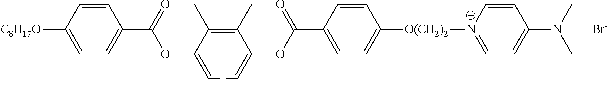
Air interface aligning agent (P-1) 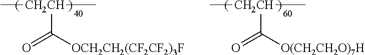
Mw. 39000

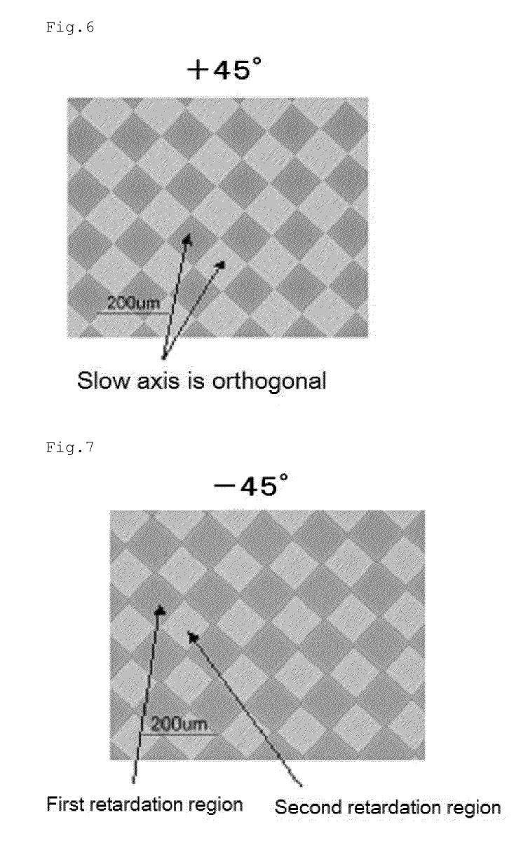

The patterned optically anisotropic layer was provided between two polarizing plates having orthogonal polarizing axes such that the slow axis of any one of the first and second retardation regions was parallel to the polarizing axis of any one of the polarizing plates. A sensitive-tint plate exhibiting a retardation of 530 nm was then disposed on the optically anisotropic layer such that its slow axis was 45° with respect to the polarizing axes of the polarizing plates defined (FIG. 5). The optically anisotropic layer turned at +45° (FIG. 6) and −45° (FIG. 7) was separately observed with a polarizing microscope (ECLIPE E600WPOL manufactured by NIKON CORPORATION). As is obvious from the results of the observation illustrated in FIGS. 5 to 7, the slow axis of the first retardation region is parallel to the slow axis of the sensitive-tint plate in the optically anisotropic layer turned at +45°; hence, the retardation is larger than 530 nm and the color is turned into blue (deep color portions in the monochrome drawing). In contrast, since the slow axis of the second retardation region is orthogonal to the slow axis of the sensitive-tint plate, the retardation is smaller than 530 nm and the color is turned into yellow (pale color portions in the monochrome drawing). The opposite results are obtained in the optically anisotropic layer turned at −45°.

### Evaluation of Optical Film

The resulting optical film was subjected to measurement of the tilt angle of the molecules of the discotic liquid crystal at the interface to the alignment film, the tilt angle of the molecules of the discotic liquid crystal at the air interface, an Re, and an Rth with “KOBRA 21ADH” (manufactured by Oji scientific instruments) in accordance with the procedure described above. Table 1 shows the results of the measurement. In the table, the term “vertical” refers to a tilt angle of 70 to 90°. In addition, the direction of the slow axis of the optically anisotropic layer included in the optical film was determined with “KOBRA 21ADH” (manufactured by Oji scientific instruments) in accordance with the procedure described above. Table 1 shows the direction of the slow axis of the optically anisotropic layer relative to the rubbed direction of the alignment film.

The results shown in Table 1 elucidate the following phenomenon: The molecules of the discotic liquid crystal are aligned on the unidirectionally rubbed alignment film composed of polyvinyl alcohol (PVA) in the presence of a pyridinium salt compound and a fluoroaliphatic group-containing copolymer and then exposed to light at variable heating temperatures, which enables the production of the patterned optically anisotropic layer being in an vertical alignment state and having the first and second retardation regions with orthogonal slow axes.

### Example 2

An optical film including a patterned optically anisotropic layer was produced as in Example 1 except that the coating solution for an optically anisotropic layer had the composition described below. The optically anisotropic layer had a thickness of 0.8 μm.

Composition for Optically Anisotropic Layer

| | | |
|---|---|---|
| Discotic liquid crystal E-2 | 100 | parts by mass |
| Alignment film interface aligning agent (II-1) | 1.0 | parts by mass |
| Air interface aligning agent (P-2) | 0.3 | parts by mass |
| Photopolymerization initiator | 3.0 | parts by mass |
| (IRGACURE 907 manufactured by BASF Japan Ltd.) | | |
| Sensitizer | 1.0 | parts by mass |
| (KAYACURE DETX manufactured by Nippon Kayaku Co., Ltd.) | | |
| Methyl ethyl ketone | 300 | parts by mass |

Discotic liquid crystal E-2 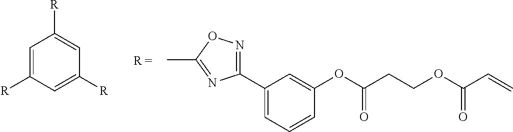
Air interface aligning agent (P-2) 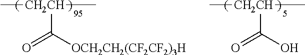
Mw. 13000

The direction of the slow axis of the optically anisotropic layer included in the resulting optical film was determined as in Example 1. Table 1 shows the direction of the slow axis of the optically anisotropic layer relative to the rubbed direction of the alignment film. The results shown in Table 1 elucidate the following phenomenon: The molecules of the discotic liquid crystal are aligned on the unidirectionally rubbed PVA alignment film in the presence of a pyridinium salt compound and a fluoroaliphatic group-containing copolymer and then are exposed to light at variable heating temperatures, which enables the production of the patterned optically anisotropic layer being in an vertical alignment state and having the first and second retardation regions with orthogonal slow axes.

### Example 3

Production of Transparent Support Provided with Rubbed Alignment Film

### Production of Transparent Support

The following composition was put into a mixing tank and then stirred while being heated for dissolution to prepare a cellulose acylate solution A.

Composition of Cellulose Acylate Solution A

| | | |
|---|---|---|
| Cellulose acetate (degree of polymerization: 2.86) | 100 | pats by mass |
| Triphenyl phosphate (plasticizer) | 7.8 | parts by mass |
| Biphenyl diphenyl phosphate (plasticizer) | 3.9 | parts by mass |
| Methylene chloride (first solvent) | 300 | pars by mass |
| Methanol (second solvent) | 54 | parts by mass |
| 1-Butanol | 11 | parts by mass |

The following composition was put into another mixing tank and then stirred while being heated for dissolution to prepare an additive solution B.

Composition of Additive Solution B

| | |
|---|---|
| Compound B1 (Re reducer) described below | 40 parts by mass |
| Compound B2 (wavelength dispersion-controlling | 4 parts by mass |
| agent) described below | |
| Methylene chloride (first solvent) | 80 pars by mass |
| Methanol (second solvent) | 20 parts by mass |

Compound B1 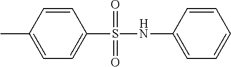 [SMILES: Cc1ccc(S(=O)(=O)Nc2ccccc2)cc1]
Compound B2

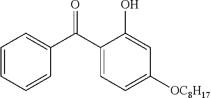

### Production of Transparent Support Composed of Cellulose Acetate

The additive solution B (40 parts by mass) was added to the cellulose acylate solution A (477 parts by mas), and then the mixture was thoroughly stirred to prepare a dope. The dope was cast from a casting port onto a drum cooled at 0°. The film containing a 70 mass % residual solvent was separated from the drum and held at its two ends in the width direction with a pin tenter (a pin tenter illustrated in FIG. 3 of JP-A-H4-1009), and then the film was dried at a tenter width enabling the film to be stretched by 3% in a lateral direction (direction orthogonal to the mechanical direction) at a residual solvent content of 3 to 5 mass %. The resulting film was passed through the rolls being a heater for further drying to produce a cellulose acetate transparent support having a thickness of 60 μm. The transparent support exhibited an Re(550) of 2.0 nm and an Rth of 12.3 nm.

### Alkali-Saponification Treatment

The cellulose acetate film was allowed to pass through dielectric heating rolls at 60° C. to increase the surface temperature of the film to 40° C. Then, an alkaline solution containing the following components was applied onto one surface of the film with a bar coater into a density of 14 ml/m², and then the product was transported for 10 seconds with a steam far-infrared heater (manufactured by NORITAKE CO., LIMITED) kept at 110° C. Pure water (3 ml/m²) was then applied onto the product in a similar manner with a bar coater. Subsequently, the product was subjected to three cycles of water washing with a fountain coater and water removal with an air knife and then passed through a drying zone at 70° C. for 10 seconds for drying to produce a cellulose acetate transparent support subjected to an alkali-saponification treatment.

Alkaline Solution Composition

| | | |
|---|---|---|
| Potassium hydroxide | 4.7 | parts by mas |
| Water | 15.8 | parts by mas |
| Isopropyl alcohol | 63.7 | parts by mas |
| Surfactant [SF-1: C₁₄H₂₉O(CH₂CH₂O)₂₀H] | 1.0 | parts by mas |
| Propylene glycol | 14.8 | parts by mas |

Production of Transparent Support Provided with Rubbed Alignment Film

A coating solution for a rubbed alignment film containing the following components was sequentially applied onto the saponified surface of the support with a #14 wire bar. The product was winded at 60° C. for 60 seconds and further winded at 100° C. for 120 seconds to form a dried alignment film. The alignment film had a thickness of 0.9 μm.

| | | |
|---|---|---|
| Coating Solution Composition for Formation of | 10 | parts by mass |
| Modified polyvinyl alcohol PVA-1 described below | | |
| Water | 371 | parts by mass |
| Methanol | 119 | parts by mass |
| Glutaraldehyde | 0.5 | parts by mass |

Modified polyvinylalcohol PVA-1

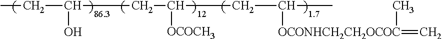

A surface of the alignment film was rubbed in the longitudinal direction of the film.

### Production of Patterned Optically Anisotropic Layer

A coating solution for an optically anisotropic layer composed of the following components was applied with a bar coater into a density of 4 ml/m². The product was dried at a surface temperature of 80° C. for 1 min into a liquid crystal phase for uniform molecular alignment which was then cooled to room temperature. A striped mask was subsequently disposed on the substrate to which the coating solution for an optically anisotropic layer had been applied, and the product was then irradiated with ultraviolet rays for 5 seconds with an air-cooled metal halide lamp of 20 mW/cm² (manufactured by EYE GRAPHICS CO., LTD.) in air to fix the alignment state, thereby forming a first retardation region. The surface temperature was then increased to 115° C. to temporarily convert the alignment state into an isotropic phase and then decreased to 100° C., and the temperature was kept to heat the product for 1 min for uniform molecular alignment. The temperature was then decreased to room temperature, and the entire product was exposed to light at an illuminance of 20 mW/cm² for 20 seconds to fix the alignment state, thereby forming a second retardation region. Finally, the product was cylindrically rolled up into an optical film. The first and second retardation regions have orthogonal slow axes, and the film had a thickness of 0.9 μm.

Composition for Optically Anisotropic Layer

| | | |
|---|---|---|
| Discotic liquid crystal E-1 | 100.0 | parts by mass |
| Alignment film interface aligning agent (II-1) | 1.0 | parts by mass |
| Below air interface aligning agent (P-2) | 0.4 | parts by mass |
| Ethylene oxide-modified trimethylolpropane | 10.0 | parts by mass |
| triacrylate VISCOAT #360 manufactured by | | |
| OSAKA ORGANIC CHEMICAL INDUSTRY | | |
| LTD.) | | |
| Photopolymerization initiator | 3.0 | parts by mass |
| (IRGACURE 907 manufactured by BASF | | |
| Japan Ltd.) | | |
| Sensitizer | 1.0 | parts by mass |
| (KAYACURE DETX manufactured by | | |
| Nippon Kayaku Co., Ltd.) | | |
| Methyl ethyl ketone | 300.0 | parts by mass |

Alignment agent for air interface (P-2) 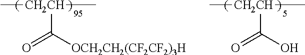
Mw. 13000

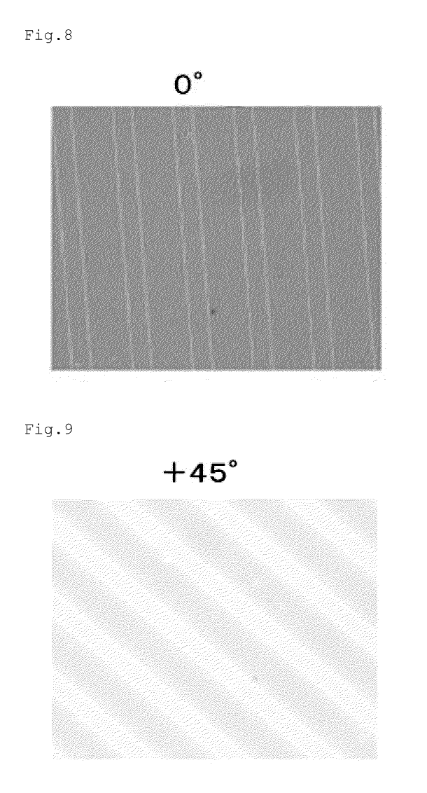

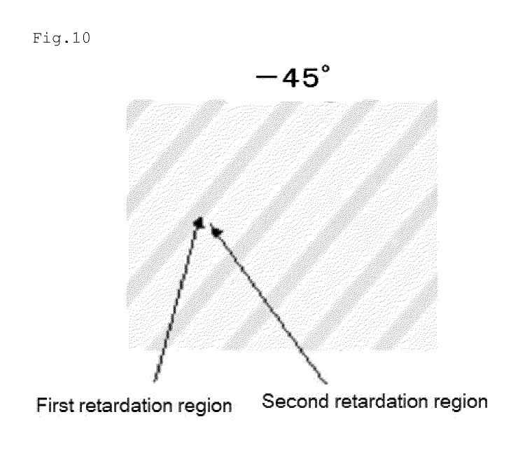

The patterned optically anisotropic layer was provided between two polarizing plates having orthogonal polarizing axes such that the slow axis of any one of the first and second retardation regions was parallel to the polarizing axis of any one of the polarizing plates. Then, a sensitive-tint plate exhibiting a retardation of 530 nm was disposed on the optically anisotropic layer such that its slow axis was 45° with respect to the polarizing axes of the polarizing plates defined (FIG. 8). The optically anisotropic layer turned at +45° (FIG. 9) and −45° (FIG. 10) was separately observed with a polarizing microscope (ECLIPE E600WPOL manufactured by NIKON CORPORATION). As is obvious from the results of the observation illustrated in FIGS. 8 to 10, the slow axis of the first retardation region is parallel to the slow axis of the sensitive-tint plate in the optically anisotropic layer turned at +45°; hence, the retardation is larger than 530 nm and the color is turned into blue (deep color portions in the monochrome drawing). In contrast, since the slow axis of the second retardation region is orthogonal to the slow axis of the sensitive-tint plate, the retardation is smaller than 530 nm and the color is turned into yellow (pale color portions in the monochrome drawing). The opposite results are obtained in the optically anisotropic layer turned at −45°.

### Evaluation of Optical Film

The resulting optical film was subjected to measurement of the tilt angle of the molecules of the discotic liquid crystal at the interface to the alignment film, the tilt angle of the molecules of the discotic liquid crystal at the air interface, an Re, and an Rth with “KOBRA 21ADH” (manufactured by Oji scientific instruments) in accordance with the procedure described above. Table 1 shows the results of the measurement. In the table, the term “vertical” refers to a tilt angle of 70° to 90°. In addition, the direction of the slow axis of the optically anisotropic layer included in the optical film was determined with “KOBRA 21ADH” (manufactured by Oji scientific instruments) in accordance with the procedure described above. Table 1 shows the direction of the slow axis of the optically anisotropic layer relative to the rubbed direction of the alignment film.

The results shown in Table 1 elucidate the following phenomenon: The molecules of the discotic liquid crystal are aligned on the unidirectionally rubbed PVA alignment film in the presence of a pyridinium salt compound and a fluoroaliphatic group-containing copolymer and then exposed to light at variable heating temperatures, which enables the production of the patterned optically anisotropic layer being in an vertical alignment state and having the first and second retardation regions with orthogonal slow axes.

### Example 4

### Production of Optical Film

An optical film including a patterned optically anisotropic layer was produced as in Example 3 except that a striped mask was used, each stripe having a width of 100 μm.

### Production of Antireflection Film

### Preparation of Coating Solution for Hardcoat Layer

The following composition was put into a mixing tank and then stirred to prepare a coating solution for a hardcoat layer.

Cyclohexanone (100 parts by mas), polyfunctional acrylate partially modified with caprolactone (DPCA-20 manufactured by Nippon Kayaku Co., Ltd., 750 parts by mass), silica sol (ORGANOSILICASOL MIBK-ST manufactured by Nissan Chemical Industries, Ltd., 200 parts by mass), and a photo initiator (IRGACURE 184 manufactured by BASF Japan Ltd., 50 parts by mass) were added to methyl ethyl ketone (900 parts by mass), and then the mixture was stirred. The resulting mixture was filtered through a polypropylene filter having a pore size of 0.4 μm to prepare a coating solution for a hardcoat layer.

### Preparation of Coating Solution A for Middle-Refractive Layer

A mixture of dipentaerythritol pentaacrylate and dipentaerythritol hexaacrylate (DPHA, 1.5 parts by mass), a photopolymerization initiator (IRGACURE 907 manufactured by BASF Japan Ltd., 0.05 parts by mas), methyl ethyl ketone (66.6 parts by mass), methyl isobutyl ketone (7.7 parts by mass), and cyclohexanone (19.1 parts by mass) were added to a ZrO₂ fine particle-containing hardcoat agent [DeSolite Z7404 manufactured by JSR Corporation (5.1 parts by mass, refractive index: 1.72, solid content: 60 mass %, content of zirconium oxide fine particles: 70 mass % relative to the solid content, average particle size of zirconium oxide fine particles: approximately 20 nm, and solvent composition: methyl isobutyl ketone:methyl ethyl ketone=9:1)], and then the mixture was thoroughly stirred. The resulting mixture was filtered through a polypropylene filter having a pore size of 0.4 μm to prepare a coating solution A for a middle-refractive layer.

### Preparation of Coating Solution B for Middle-Refractive Layer

A mixture of dipentaerythritol pentaacrylate and dipentaerythritol hexaacrylate (DPHA, 4.5 parts by mass), a photopolymerization initiator (IRGACURE 907 manufactured by BASF Japan Ltd., 0.14 parts by mas), methyl ethyl ketone (66.5 parts by mass), methyl isobutyl ketone (9.5 parts by mass), and cyclohexanone (19.0 parts by mass) were mixed and then thoroughly stirred. The resulting mixture was filtered through a polypropylene filter having a pore size of 0.4 μm to prepare a coating solution B for a middle-refractive-index layer.

The coating solutions A and B for a middle-refractive layer were mixed in a proper ratio so as to provide a refractive index of 1.36 and a film thickness of 90 μm to prepare a middle-refractive coating solution.

### Preparation of Coating Solution for High-Refractive Layer

A mixture of dipentaerythritol pentaacrylate and dipentaerythritol hexaacrylate (DPHA, 0.75 parts by mass), methyl ethyl ketone (62.0 parts by mass), methyl isobutyl ketone (3.4 parts by mass), and cyclohexanone (1.1 parts by mass) were added to a ZrO₂ fine particle-containing hardcoat agent [DeSolite Z7404 manufactured by JSR Corporation (14.4 parts by mass, refractive index: 1.72, solid content: 60 mass %, content of zirconium oxide fine particles: 70 mass % relative to the solid content, average particle size of zirconium oxide fine particles: approximately 20 nm, containing a photopolymerization initiator, and solvent composition: methyl isobutyl ketone:methyl ethyl ketone=9:1)], and then the mixture was thoroughly stirred. The resulting mixture was filtered through a polypropylene filter having a pore size of 0.4 μm to prepare a coating solution C for a high-refractive layer.

### Preparation of Coating Solution for Low-refractive Layer

### Synthesis of Perfluoroolefin Copolymer (1)

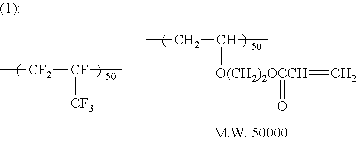

In this structure, 50:50 represents a molar ratio.

Ethyl acetate (40 ml), hydroxyethyl vinyl ether (14.7 g), and dilauroyl peroxide (0.55 g) were put into a 100 ml stainless autoclave with a stirrer, and the autoclave was purged with nitrogen gas. Hexafluoropropylene (HFP, 25 g) was introduced into the autoclave, and then the internal temperature of the autoclave was increased to 65° C. The autoclave exhibited a pressure of 0.53 MPa (5.4 kg/cm²) when the internal temperature reached 65° C. The internal temperature was maintained for 8 hr to facilitate the reaction, the heating was then stopped when the pressure reached 0.31 MPa (3.2 kg/cm²), and then the mixture was allowed to stand for cooling. Unreacted monomers were removed after the internal temperature decreased to room temperature, and then the reaction solution was taken out from the autoclave. The reaction solution was introduced into significantly excess hexane, and the solvent was removed by decantation to recover the precipitated polymer. The polymer was further dissolved in a small amount of ethyl acetate, and then residual monomers were entirely removed from hexane through two precipitation operations. The product was dried to give a polymer (28 g). The polymer (20 g) was dissolved in N,N-dimethylacetamide (100 ml), acrylic acid chloride (11.4 g) was then added dropwise to the solution while being cooled on an ice bath, and the resulting mixture was stirred at room temperature for 10 hr. Ethyl acetate was added to the reaction solution, and then the product was washed with water. The organic phase was extracted and condensed. The resulting polymer was reprecipitated in hexane to produce perfluoroolefin copolymer (1) (19 g). The polymer had a refractive index of 1.422 and a weight-average-molecular weight of 50000.

### Preparation of Hollow Silica Particulate-Containing Dispersant A

Acryloyloxypropyltrimethoxysilane (30 parts by mass) and diisopropoxyaluminum ethyl acetate (1.51 parts by mass) were mixed with hollow silica particulate sol (isopropyl alcohol silica sol, CS60-IPA manufactured by JGC Catalysts and Chemicals Ltd., average particle size: 60 nm, shell thickness: 10 nm, silica content: 20 mass %, refractive index of silica particles: 1.31, and 500 parts by mass), and then deionized water (9 parts by mass) was added to the mixture. The mixture was allowed to react at 60° C. for 8 hr and then cooled to room temperature, and then acetylacetone (1.8 parts by mass) was added to the mixture to produce a dispersant. The dispersant was subjected to solvent displacement by vacuum distillation at 30 Torr while cyclohexanone was added to the dispersant such that the silica content was maintained at a certain level. The concentration of the dispersant was finally adjusted to produce a dispersant A having a solid content of 18.2 mass %. The dispersant A was analyzed by gas chromatography to determine the residual isopropyl alcohol (IPA) content, and the residual IPA content was below 0.5 mass %.

### Preparation of Coating Solution for Low-Refractive Layer

The following components were mixed and then dissolved in methyl ethyl ketone to prepare a coating solution for a low-refractive-index layer Ln6 having a solid content of 5 mass %. The unit “mass %” of each component indicates the proportion of its solid content to the total solid content of the coating solution.

| | |
|---|---|
| P-1: perfluoroolefin copolymer (1) | 15 mass % |
| DPHA: mixture of dipentaerythritol pentaacrylate and | 7 mass % |
| dipentaerythritol hexaacrylate | |
| (manufactured by Nippon Kayaku Co., Ltd.) | |
| MF1: fluorinated unsaturated compound described below, | 5 mass % |
| which is disclosed in Examples in WO2003/022906 | |
| (weight average molecular weight: 1600) | |
| 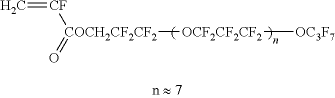 | |
| M-1: KAYARAD DPHA | 20 mass % |
| (manufactured by Nippon Kayaku Co., Ltd.) | |
| Dispersant A: hollow silica particulate-containing dispersant A | 50 mass % |
| described above (hollow silica particle sol subjected to | |
| surface modification with acryloyloxypropyltrimethoxysilane, | |
| solid content: 18.2%) | |
| Irg 127: photopolymerization initiator | 3 mass % |
| (IRGACURE 127 manufactured by BASF Japan Ltd.) | |

The coating solution for a hardcoat layer, which had the composition described above, was applied onto the optical film with a gravure coater. The product was dried at 100° C., and then the coating layer was cured through irradiation with ultraviolet rays using an air-cooled metal halide lamp of 160 W/cm² (manufactured by EYE GRAPHICS CO., LTD.) at an illuminance of 400 mW/cm² and a dose of 150 mJ/cm² under a nitrogen purge for a reduction in the oxygen content to a level below 1.0 volume % to form a hardcoat layer A having a thickness of 12 μm.

The coating solutions for a middle-refractive layer, high-refractive-index layer, and low-refractive-index layer were applied with a gravure coater. The middle-refractive layer was dried at 90° C. for 30 seconds and cured through irradiation with ultraviolet rays using an air-cooled metal halide lamp of 180 W/cm² (manufactured by EYE GRAPHICS CO., LTD.) at an illuminance of 300 mW/cm² and a dose of 240 mJ/cm² under a nitrogen purge for a reduction in the oxygen content to a level below 1.0 volume %.

The high-refractive layer was dried at 90° C. for 30 seconds and cured through irradiation with ultraviolet rays using an air-cooled metal halide lamp of 240 W/cm² (manufactured by EYE GRAPHICS CO., LTD.) at an illuminance of 300 mW/cm² and a dose of 240 mJ/cm² under a nitrogen purge for a reduction in the oxygen content to a level below 1.0 volume %.

The low-refractive layer was dried at 90° C. for 30 seconds and cured through irradiation with ultraviolet rays using an air-cooled metal halide lamp of 240 W/cm² (manufactured by EYE GRAPHICS CO., LTD.) at an illuminance of 600 mW/cm² and a dose of 600 mJ/cm² under a nitrogen purge for a reduction in the oxygen content to a level below 0.1 volume %.

### Production of Polarizing Plate

Each of the adhesive coating solution and the coating solution (these are described below) for an upper layer B was applied onto the transparent-support-side surface of the film described above into a density of 20 ml/m² and then dried at 100° C. for 5 min to produce a film sample including an adhesive layer.

Adhesive Coating Solution

| | | |
|---|---|---|
| Water-soluble polymer (m) described below | 0.5 | g |
| Acetone | 40 | ml |
| Ethyl acetate | 55 | ml |
| Isopropyl alcohol | 5 | m |

Coating Solution for Upper Layer B

| | | |
|---|---|---|
| Polyvinyl alcohol (Gohsenol NH-26 manufactured by | 0.3 | g |
| The Nippon Synthetic Chemical Industry Co., Ltd.) | | |
| Saponin (surfactant manufactured by Merck KGaA) | 0.03 | g |
| Pure water | 57 | ml |
| Methanol | 40 | ml |
| Methyl propylene glycol | 3 | ml |

Water-soluble polymer (m)
Water-soluble Polymer (m) 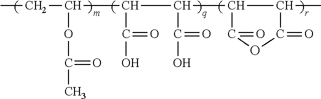
( m = 50, q = 25, r = 25 )

A rolled polyvinyl alcohol film having a thickness of 80 μm was sequentially stretched to 5 times in an aqueous iodine solution and then dried to produce a polarizing film having a thickness of 30 μm. The polarizing film was bonded to the adhesive layer of the film, and the other side of the polarizing film was subjected to an alkali-saponification treatment and then bonded to a commercially available cellulose acetate film (FUJITAC TD80UF manufactured by FUJIFILM Corporation, Re(550): 3 nm, and |Rth(630)|: 50 nm) with another adhesive layer interposed therebetween to produce a polarizing plate.

Evaluation of Polarizing Plate Incorporated into Liquid Crystal Display Device

The patterned retardation plate and front polarizing plate of a 3D monitor provided with circular polarizing glasses (manufactured by Zalman Tech Co., Ltd) were removed, and the polarizing plate described above was attached to the monitor.

Stereoscopic images were displayed on the resulting 3D monitor and then observed with circular polarizing glasses for left and right eyes, and the observed stereoscopic images were clear without crosstalk.

### Example 5

### Production of Optical Film

An optical film was produced as in Example 4 except that the additive B1 (Re reducer) and additive B2 (wavelength dispersion-controlling agent) were removed from the additive solution B used in the production of the cellulose acetate transparent support. The cellulose acetate transparent support had a thickness of 200 μm and exhibited an Re of 15 nm and an Rth of 102 nm at a wavelength of 550 nm.

Evaluation of Polarizing Plate Incorporated into Liquid Crystal Display Device

The polarizing plate was produced as in Example 4. The patterned retardation plate and front polarizing plate of a 3D monitor provided with circular polarizing glasses (manufactured by Zalman Tech Co., Ltd) were removed, and the polarizing plate was attached to the monitor.

Stereoscopic images were displayed on the resulting 3D monitor and then observed with circular polarizing glasses for left and right eyes, and the observed stereoscopic images involved slight crosstalk.

### Example 6

An optical film including a patterned optically retardation film was produced as in Example 1 except that the coating solution for an optically anisotropic layer had the following composition. The optically anisotropic layer had a thickness of 0.8 μm.

Composition for Optically Anisotropic Layer

| | | |
|---|---|---|
| Discotic liquid crystal E-3 | 100 | parts by mass |
| Alignment film interface aligning agent (II-1) | 1.0 | parts by mass |
| Air interface aligning agent (P-2) | 0.3 | parts by mass |
| Photopolymerization initiator | 3.0 | parts by mass |
| (IRGACURE 907 manufactured by BASF Japan | | |
| Ltd.) | | |
| Sensitizer | 1.0 | parts by mass |
| (KAYACURE DETX manufactured by Nippon | | |
| Kayaku Co., Ltd.) | | |
| Ethylene oxide-modified trimethylolpropane | 9.9 | parts by mass |
| triacrylate (VISCOAT #360 manufactured by | | |
| OSAKA ORGANIC CHEMICAL INDUSTRY | | |
| LTD.) | | |
| Methyl ethyl ketone | 300 | parts by mass |

Discotic liquid crystal E-3

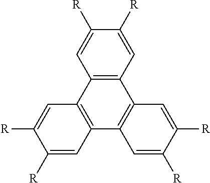

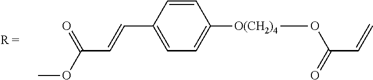

### Evaluation of Optical Film

The direction of the slow axis of the optically anisotropic layer included in the resulting optical film was determined as in Example 1. Table 1 shows the direction of the slow axis of the optically anisotropic layer relative to the rubbed direction of the alignment film. The results shown in Table 1 elucidate the following phenomenon: The molecules of the discotic liquid crystal are aligned on the unidirectionally rubbed PVA alignment film in the presence of a pyridinium salt compound and a fluoroaliphatic group-containing copolymer and then exposed to light at variable heating temperatures, which enables the production of the patterned optically anisotropic layer being in an vertical alignment state and having the first and second retardation regions with orthogonal slow axes.

### Example 7

An optical film including a patterned optically retardation film was produced as in Example 1 except that the coating solution for an optically anisotropic layer had the following composition. The optically anisotropic layer had a thickness of 0.8 μm.

Composition for Optically Anisotropic Layer

| | | |
|---|---|---|
| Discotic liquid crystal E-2 | 100 | parts by mass |
| Alignment film interface aligning agent (II-2) | 1.0 | parts by mass |
| Air interface aligning agent (P-2) | 0.3 | parts by mass |
| Photopolymerization initiator | 3.0 | parts by mass |
| (IRGACURE 907 manufactured by BASF Japan Ltd.) | | |
| Sensitizer | 1.0 | parts by mass |
| (KAYACURE DETX manufactured by Nippon Kayaku Co., Ltd.) | | |
| Methyl ethyl ketone | 300 | parts by mass |

Alignment film interface aligning agent (II-2)

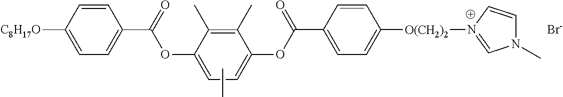

### Evaluation of Optical Film

The direction of the slow axis of the optically anisotropic layer included in the resulting optical film was determined as in Example 1. Table 1 shows the direction of the slow axis of the optically anisotropic layer relative to the rubbed direction of the alignment film. The results shown in Table 1 elucidate the following phenomenon: The molecules of the discotic liquid crystal are aligned on the unidirectionally rubbed PVA alignment film in the presence of an imidazolium salt compound and a fluoroaliphatic group-containing copolymer and then exposed to light at variable heating temperatures, which enables the production of the patterned optically anisotropic layer being in an vertical alignment state and having the first and second retardation regions with orthogonal slow axes.

### Comparative Example 1

### Production of Optical Film

An optical film was produced as in Example 3 except for the following change in the process of producing an optically anisotropic layer. The alignment film had a thickness of 0.9 μm, and the optically anisotropic layer had a thickness of 0.9 μm.

### Production of Optically Anisotropic Layer

The coating solution for an optically anisotropic layer used in Example 3 was applied with a bar coater into a density of 4 ml/m². The product was dried at a surface temperature of 80° C. for 1 min into a liquid crystal phase for uniform molecular alignment and then cooled to room temperature. The entire product was irradiated with ultraviolet rays for 25 seconds with an air-cooled metal halide lamp of 20 mW/cm² (manufactured by EYE GRAPHICS CO., LTD.) in air to fix the alignment state, thereby forming an optically anisotropic layer.

### Evaluation of Optical Film

The resulting optical film was subjected to measurement of the tilt angle of the molecules of the discotic liquid crystal at the interface to the alignment film, the tilt angle of the molecules of the discotic liquid crystal at the air interface, an Re, and an Rth with “KOBRA 21ADH” (manufactured by Oji scientific instruments) in accordance with the procedure described above. Table 1 shows the results of the measurement. In Table 1, the term “vertical” refers to a tilt angle of 70° to 90°. In addition, the direction of the slow axis of the optically anisotropic layer included in the optical film was determined with “KOBRA 21ADH” (manufactured by Oji scientific instruments) in accordance with the procedure described above. Table 1 shows the direction of the slow axis of the optically anisotropic layer relative to the rubbed direction of the alignment film.

The results shown in FIG. 1 demonstrate that a non-patterned optically anisotropic retardation layer having a slow axis orthogonal to the rubbed direction is provided whereas the molecules of the discotic liquid crystal are vertically aligned.

### Comparative Example 2

### Production of Optical Film

An optical film was produced as in Example 3 except for the following change in the process of producing an optically anisotropic layer. The alignment film had a thickness of 0.9 μm, and the optically anisotropic layer had a thickness of 0.9 μm.

### Production of Optically Anisotropic Layer

The coating solution for an optically anisotropic layer used in Example 3 was applied with a bar coater into a density of 4 ml/m². The surface temperature was increased to 115° C. to temporarily convert the alignment state into an isotropic phase and then decreased to 100° C., and the temperature was kept to heat the product for 1 min for uniform molecular alignment. The temperature was then decreased to room temperature, and the entire product was exposed to light at an illuminance of 20 mW/cm² for 25 seconds to fix the alignment state, thereby forming an optically anisotropic layer.

### Evaluation of Optical Film

The resulting optical film was subjected to measurement of the tilt angle of the molecules of the discotic liquid crystal at the interface to the alignment film, the tilt angle of the molecules of the discotic liquid crystal at the air interface, an Re, and an Rth with “KQBRA 21ADH” (manufactured by Oji scientific instruments) in accordance with the procedure described above. Table 1 shows the results of the measurement. In Table 1, the term “vertical” refers to a tilt angle of 70° to 90°. In addition, the direction of the slow axis of the optically anisotropic layer included in the optical film was determined with “KOBRA 21ADH” (manufactured by Oji scientific instruments) in accordance with the procedure described above. Table 1 shows the direction of the slow axis of the optically anisotropic layer relative to the rubbed direction of the alignment film.

The results shown in FIG. 1 demonstrate that a non-patterned optically anisotropic retardation layer having a slow axis parallel to the rubbed direction is provided whereas the molecules of the discotic liquid crystal are vertically aligned.

### Comparative Example 3

Evaluation of Polarizing Plate Incorporated into Liquid Crystal Display Device

A 3D monitor was produced as in Example 4 except that a polarizing plate including the optical film of Comparative Example 1 was used.

Stereoscopic images were displayed on the 3D monitor and then observed with circular polarizing glasses for left and right eyes. Crosstalk was remarkably caused, which prevented the stereoscopic images from being properly observed.

### Comparative Example 4

Evaluation of Polarizing Plate Incorporated into Liquid Crystal Display Device

A 3D monitor was produced as in Example 4 except that a polarizing plate including the optical film of Comparative Example 2 was used.

Stereoscopic images were displayed on the 3D monitor and then observed with circular polarizing glasses for left and right eyes. Crosstalk was remarkably caused, which prevented the stereoscopic images from being properly observed.

TABLE 1

| | | | Alignment film | | Air interface | | | | | | | |
|---|---|---|---|---|---|---|---|---|---|---|---|---|
| | | | aligning agent | | aligning agent | | | | | | Optical | |
| | | | | Additive | | Additive | Heating | | Tilt angle | | properties | |
| | Liquid | Alignment | | amount | | amount | temperature | Direction of | Alignment | Air | Re | Rth |
| | crystal | film | Material | (mass %) | Material | (mass %) | (° C.) | slow axis | film | interface | (nm) | (nm) |
| Example 1 | E-1 | PVA103 | II-1 | 1.0 | P-1 | 0.4 | 80 | Orthogonal | Vertical | Vertical | 140 | −38 |
| | | | | | | | 140 | Parallel | Vertical | Vertical | 140 | −38 |
| Example 2 | E-2 | PVA103 | II-1 | 1.0 | P-2 | 0.3 | 80 | Orthogonal | Vertical | Vertical | 130 | −35 |
| | | | | | | | 140 | Parallel | Vertical | Vertical | 130 | −35 |
| Example 3 | E-1 | PVA1 | II-1 | 1.0 | P-2 | 0.4 | 80 | Orthogonal | Vertical | Vertical | 137 | −22 |
| | | | | | | | 140 | Parallel | Vertical | Vertical | 137 | −22 |
| Example 6 | E-3 | PVA103 | II-1 | 1.0 | P-2 | 0.3 | 115 | Orthogonal | Vertical | Vertical | 140 | −38 |
| | | | | | | | 145 | Parallel | Vertical | Vertical | 140 | −38 |
| Example 7 | E-2 | PVA103 | II-2 | 1.0 | P-2 | 0.3 | 80 | Orthogonal | Vertical | Vertical | 130 | −35 |
| | | | | | | | 140 | Parallel | Vertical | Vertical | 130 | −35 |
| Comparative | E-1 | PVA103 | II-1 | 1.0 | P-2 | 0.4 | 80 | Orthogonal | Vertical | Vertical | 137 | −22 |
| Example 1 | | | | | | | | | | | | |
| Comparative | E-1 | PVA1 | II-1 | 1.0 | P-2 | 0.4 | 140 | Parallel | Vertical | Vertical | 137 | −22 |
| Example 2 | | | | | | | | | | | | |

### Reference Example 1

An optical film including a patterned optically anisotropic layer was produced as in Example 1 except that the coating solution for an optically anisotropic layer had the following composition. The optically anisotropic layer had a thickness of 0.8 μm.

Composition for Optically Anisotropic Layer

| | | |
|---|---|---|
| Discotic liquid crystal E-4 | 100 | parts by mass |
| Alignment film interface aligning agent (II-1) | 1.0 | parts by mass |
| Air interface aligning agent (P-2) | 0.3 | parts by mass |
| Photopolymerization initiator | 3.0 | parts by mass |
| (IRGACURE 907 manufactured by BASF Japan | | |
| Ltd.) | | |
| Sensitizer | 1.0 | parts by mass |
| (KAYACURE DETX manufactured by | | |
| Nippon Kayaku Co., Ltd.) | | |
| Ethylene oxide-modified trimethylolpropane | 9.9 | parts by mass |
| triacrylate (VISCOAT #360 manufactured by | | |
| OSAKA ORGANIC CHEMICAL INDUSTRY | | |
| LTD.) | | |
| Methyl ethyl ketone | 300 | parts by mass |

Discotic liquid crystal E-4

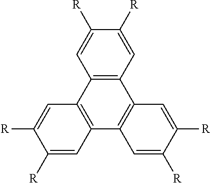

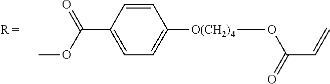

### Evaluation of Optical Film

The direction of the slow axis of the optically anisotropic layer included in the resulting optical film was determined as in Example 1. The molecules of the discotic liquid crystal E-4, which was triphenylene discotic liquid crystal having no —C═C-bonding in the groups for connecting the side chains to the discotic core, were less likely to be aligned into the orthogonal alignment state, and the resulting optical film was inferior to the optical films of Examples in terms of formation of the pattern.

### Reference Example 2

An optical film including a patterned optically anisotropic layer was produced as in Example 1 except that the coating solution for an optically anisotropic layer had the following composition. The optically anisotropic layer had a thickness of 0.8 μm.

Composition for Optically Anisotropic Layer

| | | |
|---|---|---|
| Discotic liquid crystal E-1 | 100 | parts by mass |
| Alignment film interface aligning agent (II-3) | 1.0 | parts by mass |
| Air interface aligning agent (P-2) | 0.3 | parts by mass |
| Photopolymerization initiator | 3.0 | parts by mass |
| (IRGACURE 907 manufactured by BASF Japan | | |
| Ltd.) | | |
| Sensitizer | 1.0 | parts by mass |
| (KAYACURE DETX manufactured by Nippon | | |
| Kayaku Co., Ltd.) | | |
| Methyl ethyl ketone | 300 | parts by mass |

Alignment film interface aligning agent (II-3)

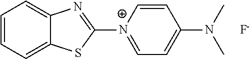

### Evaluation of Optical Film

The direction of the slow axis of the optically anisotropic layer included in the resulting optical film was determined as in Example 1. The liquid crystal molecules were less likely to be aligned into the orthogonal alignment state with use of the pyridinium salt not represented by Formula (2), and the resulting optical film was inferior to the optical films of Examples in terms of formation of the pattern.

The present disclosure relates to the subject matter contained in Japanese Patent Application No. 141346/2010, filed on Jun. 22, 2010, which is expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. An optical film comprising:
a transparent support;
an alignment film subjected to a unidirectional alignment treatment; and
an optically anisotropic layer formed of one kind of composition mainly containing liquid crystal having a polymerizable group, wherein the optically anisotropic layer is a patterned optically anisotropic layer having first retardation regions and second retardation regions alternately disposed in a plane, and the first retardation regions and the second retardation regions have in-plane slow axes orthogonal to each other.

2. The optical film according to claim 1, wherein the alignment film is an unidirectionally rubbed alignment film.

3. The optical film according to claim 1, wherein the optical film has an in-plane retardation Re(550) of 110 to 165 nm at a wavelength of 550 nm.

4. The optical film according to claim 1, wherein the transparent support has an Re(550) of 0 to 10 nm.

5. The optical film according to claim 1, wherein the optical film has a thickness-direction retardation Rth (550) satisfying the relationship: |Rth(550)|≦20 at a wavelength of 550 nm, where Rth(550) are retardation (nm) along the thickness direction at a wavelength of 550 nm.

6. The optical film according to claim 1, wherein the alignment film is a film containing mainly composed of modified polyvinyl alcohol or unmodified polyvinyl alcohol.

7. The optical film according to claim 1, wherein the liquid crystal having a polymerizable group is discotic liquid crystal.

8. The optical film according to claim 1, wherein the optically anisotropic layer further comprises at least any one of a pyridinium compound and an imidazolium compound.

9. The optical film according to claim 1, wherein the optically anisotropic layer further comprises a pyridinium compound represented by Formula (2a) or an imidazolium compound represented by Formula (2b); 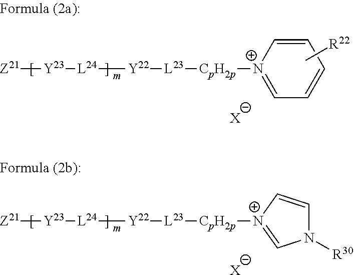
wherein L²³ and L²⁴ each represent a divalent linking group (including a single bond); R²² represents any one of an hydrogen atom, an un-substituted amino group, and a substituted amino group having 1 to 20 carbon atoms; when R²² is a dialkyl-substituted amino group, two alkyl groups may be bonded to each other to form a nitrogen-containing heterocycle; X represents an anion; Y²² and Y²³ each represent a divalent linking group having any one of 5 and 6-membered rings as a partial structure; m is 1 or 2; when m is 2, multiple Y²³'s and L²⁴'s may be the same or different; Z²¹ represents a monovalent group selected from the group consisting of halogen-substituted phenyl, nitro-substituted phenyl, cyano-substituted phenyl, phenyl substituted with an alkyl group having 1 to 10 carbon atoms, phenyl substituted with an alkoxy group having 2 to 10 carbon atoms, an alkyl group having 1 to 12 carbon atoms, an alkynyl group having 2 to 20 carbon atoms, an alkoxy group having 1 to 12 carbon atoms, an alkoxycarbonyl group having 2 to 13 carbon atoms, an aryloxycarbonyl group having 7 to 26 carbon atoms, and an arylcarbonyloxy group having 7 to 26 carbon atoms; p represents an integer of from 1 to 10, and R³⁰ represents a hydrogen atom or an alkyl group having 1 to 12 carbon atoms.

10. The optical film according to claim 1, wherein the optically anisotropic layer further comprises at least one fluoroaliphatic group-containing copolymer.

11. The optical film according to claim 1, wherein the liquid crystal having a polymerizable group is discotic liquid crystal, and the molecules of the discotic liquid crystal are aligned into a vertically alignment state in the optically anisotropic layer.

12. The optical film according to claim 1, wherein the liquid crystal having a polymerizable group is discotic liquid crystal, and the optically anisotropic layer further comprises a pyridinium compound represented by Formula (2a) or an imidazolium compound represented by Formula (2b). 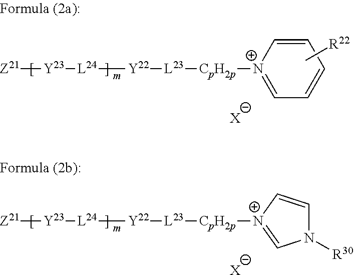
wherein L²³ and L²⁴ each represent a divalent linking group (including a single bond); R²² represents any one of an hydrogen atom, an un-substituted amino group, and a substituted amino group having 1 to 20 carbon atoms; when R²² is a dialkyl-substituted amino group, two alkyl groups may be bonded to each other to form a nitrogen-containing heterocycle; X represents an anion; Y²² and Y²³ each represent a divalent linking group having any one of 5 and 6-membered rings as a partial structure; m is 1 or 2; when m is 2, multiple Y²³'s and L²⁴'s may be the same or different; Z²¹ represents a monovalent group selected from the group consisting of halogen-substituted phenyl, nitro-substituted phenyl, cyano-substituted phenyl, phenyl substituted with an alkyl group having 1 to 10 carbon atoms, phenyl substituted with an alkoxy group having 2 to 10 carbon atoms, an alkyl group having 1 to 12 carbon atoms, an alkynyl group having 2 to 20 carbon atoms, an alkoxy group having 1 to 12 carbon atoms, an alkoxycarbonyl group having 2 to 13 carbon atoms, an aryloxycarbonyl group having 7 to 26 carbon atoms, and an arylcarbonyloxy group having 7 to 26 carbon atoms; p represents an integer of from 1 to 10, and R³⁰ represents a hydrogen atom or an alkyl group having 1 to 12 carbon atoms.

13. The optical film according to claim 1, wherein the liquid crystal having a polymerizable group is discotic liquid crystal, and the optically anisotropic layer further comprises at least one fluoroaliphatic group-containing copolymer.

14. The optical film according to claim 12, wherein the optically anisotropic layer further comprises at least one fluoroaliphatic group-containing copolymer.

15. A polarizing plate comprising:
the optical film according to claim 1; and
a polarizing film, wherein
the direction of the in-plane slow axis of each of the first and second retardation regions of the optically anisotropic layer is 45° from the direction of the absorption axis of the polarizing film.

16. The polarizing plate according to claim 15, wherein the optical film and the polarizing film are laminated with an adhesive layer interposed therebetween.

17. The polarizing plate according to claims 15, wherein at least one antireflection film is laminated as the outermost layer.

18. An image display device comprising:
a first polarizing film and a second polarizing film;
a liquid crystal cell disposed between the first and second polarizing films and including a pair of substrates and a liquid crystal layer disposed between the substrates, at least any one of the substrates having an electrode; and
the optical film according to claim 1 disposed at the outer side relative to the first polarizing film, wherein
the in-plane slow axes of each the first and second retardation regions in the optical film each are ±45° from the absorption axis direction of the first polarizing film.

19. A stereoscopic image display system comprising:
the image display device according to claim 18; and
a third polarizing plate disposed at the outer side relative to the optical film, wherein
the stereoscopic image display system enables an stereoscopic image to be visually observed through the third polarizing plate.

20. A method for manufacturing the optical film according to claim 1, the method comprising, in the sequence set forth,
forming an alignment film on a transparent support;
unidirectionally rubbing the alignment film;
applying one kind of composition mainly composed of liquid crystal having a polymerizable group onto the rubbed alignment film;
heating the laminate at a temperature T₁° C. to align liquid crystal molecules such that slow axes thereof are orthogonal to the rubbed direction;
exposing the laminate to ultraviolet rays through a photomask to fix the irradiated region in the orthogonal alignment state;
heating the laminate at a temperature T₂° C. (where T₁<T₂) to align the liquid crystal molecules in the non-irradiated region such that slow axes thereof are parallel to the rubbed direction; and
irradiating the laminate with ultraviolet rays to fix the parallel alignment state.
